(19) United States
(12) Patent Application Publication
(10) Pub. No.: US 2016/0125903 A1
(43) Pub. Date: May 5, 2016

(54) PERPENDICULAR MAGNETIC RECORDING MEDIUM HAVING AN OXIDE SEED LAYER AND RU ALLOY INTERMEDIATE LAYER

(71) Applicant: HGST Netherlands B.V., Amsterdam (NL)

(72) Inventors: Ichiro Tamai, Odawara-shi (JP); Tatsuya Hinoue, Odawara-shi (JP); Shun Tonooka, Odawara-shi (JP); Hiroaki Nemoto, Odawara-shi (JP)

(73) Assignee: HGST NETHERLANDS B.V., Amsterdam (NL)

(21) Appl. No.: 14/530,600

(22) Filed: Oct. 31, 2014

(51) Int. Cl. G11B 5/738; G11B 5/127; G11B 5/84

(52) U.S. Cl. CPC G11B 5/738; G11B 5/84; G11B 5/1278

(57) ABSTRACT

In one embodiment, a perpendicular magnetic recording medium includes a substrate; a soft magnetic underlayer positioned above the substrate; a seed layer structure positioned above the soft magnetic underlayer, the seed layer structure including a first seed layer and a second seed layer positioned above the first seed layer; an interlayer structure positioned above the seed layer structure, the interlayer structure including a first interlayer, a second interlayer positioned above the first interlayer, and a third interlayer positioned above the second interlayer; and a magnetic recording layer positioned above the interlayer structure, where the second seed layer includes a Ni alloy including at least one oxide, and where the first interlayer includes a Ru alloy.

### FIELD OF THE INVENTION

The present invention relates to data storage systems, and more particularly, this invention relates to perpendicular magnetic recording media having an oxide seed layer and a Ru alloy intermediate layer.

### BACKGROUND

The heart of a computer is a magnetic hard disk drive (HDD) which typically includes a rotating magnetic disk, a slider that has read and write heads, a suspension arm above the rotating disk and an actuator arm that swings the suspension arm to place the read and/or write heads over selected circular tracks on the rotating disk. The suspension arm biases the slider into contact with the surface of the disk when the disk is not rotating but, when the disk rotates, air is swirled by the rotating disk adjacent an air bearing surface (ABS) of the slider causing the slider to ride on an air bearing a slight distance from the surface of the rotating disk. When the slider rides on the air bearing the write and read heads are employed for writing magnetic impressions to and reading magnetic signal fields from the rotating disk. The read and write heads are connected to processing circuitry that operates according to a computer program to implement the writing and reading functions.

The volume of information processing in the information age is increasing rapidly. Accordingly, an important and ongoing goal involves increasing the amount of information able to be stored in the limited area and volume of HDDs. Increasing the areal recording density of HDDs provides one technical approach to achieve this goal. In particular, reducing the size of recording bits and components associated therewith offers an effective means to increase areal recording density. However, the continual push to miniaturize the recording bits and associated components presents its own set of challenges and obstacles. For instance, as the size of the ferromagnetic crystal grains in a magnetic recording layer become smaller and smaller, the crystal grains may become thermally unstable, such that thermal fluctuations result in magnetization reversal and the loss of recorded data. Increasing the magnetic anisotropy of the magnetic particles may improve the thermal stability thereof; however, an increase in the magnetic anisotropy requires an increase in the switching field needed to switch the magnetization of the magnetic particles during a write operation.

The use of perpendicular recording (PMR) media addresses this thermal limit and allows continued advances in areal density. A PMR medium typically includes a magnetic recording layer having an easy axis of magnetization oriented substantially perpendicular to the substrate. PMR media typically include a soft magnetic underlayer, one or more underlayers (e.g., seed layer(s) and/or interlayer(s)), and a granular magnetic recording layer. The soft magnetic underlayer serves to enhance the recording/reproduction efficiency by focusing magnetic flux into the granular magnetic recording layer. The one or more underlayers serve to control the size and/or orientation of the magnetic crystal grains in the magnetic recording layer. The granular magnetic recording layer serves to store bits of information based on the orientation of the magnetization of the magnetic crystal grains.

Often, the granular magnetic recording layer of a PMR medium may include hexagonal close packed (hcp) CoCrPt alloys, where the easy axis of magnetization lies along the c-axis. Moreover, this granular recording layer may also include one or more oxides to promote separation of the magnetic crystal grains. The CoCrPt alloy recording layer used in conventional media uses the phase separation of Co and Cr to segregate non-magnetic elements, such as Cr, at grain boundaries. A large quantity of the non-magnetic elements forming the grain boundary may be added in order to reduce medium noise. However, many of these elements are not completely segregated at the grain boundaries and often remain in the crystal grains. Thus, the magnetic anisotropic energy decreases, and maintaining the signal quality is difficult. In contrast, because oxides and magnetic crystal grains are easily separated in a granular recording layer, the medium noise may be reduced while maintaining high magnetic anisotropic energy without needing to add a large quantity of nonmagnetic elements such as Cr. For example, medium performance may be improved by improving the recording layer, as described in Japanese Unexamined Patent Application Publication No. 2003-178413 and United States Patent Application Publication No. 2006/0121319.

One way to further reduce medium noise in a PMR medium may include refining (e.g., reducing the size of) the magnetic crystal grains and/or the recording magnetization unit (magnetic cluster size) of the granular magnetic recording layer. The magnetic crystal grain size and the magnetic cluster size of the granular magnetic recording layer depend strongly on the one or more underlayers used in forming the PMR medium. In particular, to obtain a steep recording magnetic field gradient as the distance decreases between the magnetic head and the soft-magnetic underlayer, it is useful to improve the crystal orientation of the granular magnetic recording layer by using a thin interlayer and further refining/miniaturizing the magnetic crystal grain size and the magnetic cluster size. For example, United States Patent Application Publication No. 2005/0202286, Japanese Patent No. 4,019,703, Japanese Unexamined Patent Application Publication No. 2002-334424, U.S. Pat. No. 7,641,989, United States Patent Application Publication No. 2009/0195924 and United States Patent Application Publication No. 2009/0116137 disclose methods for adding metal elements to a Ru interlayer or adding oxides to the interlayer. However, although obtaining a constant effect was confirmed in these references, this effect was inadequate to realize a higher areal recording density.

Therefore, there is a current need for a PMR medium that includes a granular magnetic recording medium in which the magnetic cluster size is reduced without an increase in the oxide content, and that is thus capable of high recording density with low medium noise.

### SUMMARY

According to one embodiment, a perpendicular magnetic recording medium includes a substrate; a soft magnetic underlayer positioned above the substrate; a seed layer structure positioned above the soft magnetic underlayer, the seed layer structure including a first seed layer and a second seed layer positioned above the first seed layer; an interlayer structure positioned above the seed layer structure, the interlayer structure including a first interlayer, a second interlayer positioned above the first interlayer, and a third interlayer positioned above the second interlayer; and a magnetic recording layer positioned above the interlayer structure, where the second seed layer includes a Ni alloy including at least one oxide, and where the first interlayer includes a Ru alloy.

According to another embodiment, a method for forming a perpendicular magnetic recording medium includes providing a substrate; forming a soft magnetic underlayer above the substrate; forming a seed layer structure above the soft magnetic underlayer, the seed layer structure comprising a first seed layer and a second seed layer positioned above the first seed layer; forming an interlayer structure above the seed layer structure, the interlayer structure comprising a first interlayer, a second interlayer positioned above the first interlayer, and a third interlayer positioned above the second interlayer; and forming a magnetic recording layer above the interlayer structure, where the second seed layer comprises a Ni alloy including at least one oxide, where the first interlayer comprises a Ru alloy, and where the second interlayer is formed under a gas pressure that is higher than a gas pressure used to form the first interlayer.

Any of these embodiments may be implemented in a magnetic data storage system such as a disk drive system, which may include a magnetic head, a drive mechanism for passing a magnetic medium (e.g., hard disk) over the magnetic head, and a controller electrically coupled to the magnetic head.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a simplified drawing of a magnetic recording disk drive system, according to one embodiment.

FIG. 2A is a cross-sectional view of a perpendicular magnetic head with helical coils, according to one embodiment.

FIG. 2B is a cross-sectional view a piggyback magnetic head with helical coils, according to one embodiment.

FIG. 3A is a cross-sectional view of a perpendicular magnetic head with looped coils, according to one embodiment.

FIG. 3B is a cross-sectional view of a piggyback magnetic head with looped coils, according to one embodiment.

FIG. 4A is a schematic representation of a section of a longitudinal recording medium, according to one embodiment.

FIG. 4B is a schematic representation of a magnetic recording head and the longitudinal recording medium of FIG. 4A, according to one embodiment.

FIG. 5A is a schematic representation of a perpendicular recording medium, according to one embodiment.

FIG. 5B is a schematic representation of a recording head and the perpendicular recording medium of FIG. 5A, according to one embodiment.

FIG. 5C is a schematic representation of a recording apparatus configured to record separately on both sides of a perpendicular recording medium, according to one embodiment.

FIGS. 6A-6B are schematic representations of portions of a perpendicular magnetic medium, according to one embodiment.

FIG. 7A is a simplified schematic representation of a hexagon close packed (hcp) structure.

FIG. 7B is a simplified representation of a-axis orientation alignment for two hcp structures.

FIG. 8 is a schematic representation of a perpendicular magnetic recording medium, according to one embodiment.

FIGS. 9A-9D are schematic diagrams of the crystalline clusters in the magnetic recording layer of several perpendicular magnetic recording media, according to various embodiments.

FIGS. 10A-10D are histograms of the grain size and crystalline clusters in the magnetic recording layers of several perpendicular magnetic recording media, according to various embodiments.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

As also used herein, the term “about” denotes an interval of accuracy that ensures the technical effect of the feature in question. In various approaches, the term “about” when combined with a value, refers to plus and minus 10% of the reference value. For example, a thickness of about 10 nm refers to a thickness of 10 nm±1 nm.

The following description discloses several preferred embodiments of magnetic storage systems and/or related systems and methods, as well as operation and/or component parts thereof.

To further improve the recording density in the granular recording layer of a magnetic recording medium, several refinements may be made: the magnetic crystal grain size/diameter in the granular magnetic recording layer may be reduced; the magnetic separation of these magnetic crystal grains may be promoted; and/or the magnetic cluster size, which is the reversal unit of magnetization in the granular magnetic recording layer, may be reduced, according to several embodiments. However, even for small magnetic crystal grains, magnetic separation becomes inadequate, the magnetic cluster size (i.e., the reversal unit of magnetization) may increase, and noise cannot be reduced. With smaller crystal grain diameters, a large quantity of oxides may be added to ensure a constant grain boundary width, but the excess addition of oxides creates sub-grains, which degrades the magnetic and recording characteristics of the granular magnetic recording layer. Furthermore, high oxide concentrations in the granular magnetic recording layer may result in regions having narrow grain boundaries, which may limit the ability to further improve the magnetic and recording characteristics of the granular magnetic recording layer.

Embodiments described herein overcome the aforementioned drawbacks by providing a magnetic recording medium that includes a magnetic recording layer in which the magnetic cluster size is reduced without any increase in the oxide content in the magnetic recording layer, and is thus capable of high recording density with low medium noise. Below are several examples of general and specific embodiments relating to the use, manufacture, structure, properties, etc. of the novel magnetic media disclosed herein.

According to one general embodiment, a perpendicular magnetic recording medium includes a substrate; a soft magnetic underlayer positioned above the substrate; a seed layer structure positioned above the soft magnetic underlayer, the seed layer structure including a first seed layer and a second seed layer positioned above the first seed layer; an interlayer structure positioned above the seed layer structure, the interlayer structure including a first interlayer, a second interlayer positioned above the first interlayer, and a third interlayer positioned above the second interlayer; and a magnetic recording layer positioned above the interlayer structure, where the second seed layer includes a Ni alloy including at least one oxide, and where the first interlayer includes a Ru alloy.

According to another general embodiment, a method for forming a perpendicular magnetic recording medium includes providing a substrate; forming a soft magnetic underlayer above the substrate; forming a seed layer structure above the soft magnetic underlayer, the seed layer structure comprising a first seed layer and a second seed layer positioned above the first seed layer; forming an interlayer structure above the seed layer structure, the interlayer structure comprising a first interlayer, a second interlayer positioned above the first interlayer, and a third interlayer positioned above the second interlayer; and forming a magnetic recording layer above the interlayer structure, where the second seed layer comprises a Ni alloy including at least one oxide, where the first interlayer comprises a Ru alloy, and where the second interlayer is formed under a gas pressure that is higher than a gas pressure used to form the first interlayer.

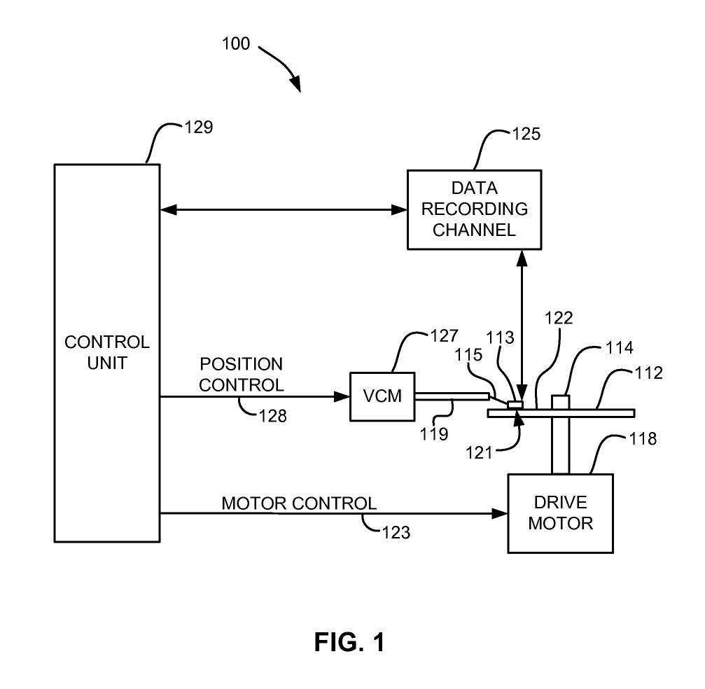

Referring now to FIG. 1, there is shown a disk drive 100 in accordance with one embodiment of the present invention. As shown in FIG. 1, at least one rotatable magnetic medium (e.g., magnetic disk) 112 is supported on a spindle 114 and rotated by a drive mechanism, which may include a disk drive motor 118. The magnetic recording on each disk is typically in the form of an annular pattern of concentric data tracks (not shown) on the disk 112. Thus, the disk drive motor 118 preferably passes the magnetic disk 112 over the magnetic read/write portions 121, described immediately below.

At least one slider 113 is positioned near the disk 112, each slider 113 supporting one or more magnetic read/write portions 121, e.g., of a magnetic head according to any of the approaches described and/or suggested herein. As the disk rotates, slider 113 is moved radially in and out over disk surface 122 so that portions 121 may access different tracks of the disk where desired data are recorded and/or to be written. Each slider 113 is attached to an actuator arm 119 by means of a suspension 115. The suspension 115 provides a slight spring force which biases slider 113 against the disk surface 122. Each actuator arm 119 is attached to an actuator 127. The actuator 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of disk 112 generates an air bearing between slider 113 and disk surface 122 which exerts an upward force or lift on the slider. The air bearing thus counter-balances the slight spring force of suspension 115 and supports slider 113 off and slightly above the disk surface by a small, substantially constant spacing during normal operation. Note that in some embodiments, the slider 113 may slide along the disk surface 122.

The various components of the disk storage system are controlled in operation by control signals generated by controller 129, such as access control signals and internal clock signals. Typically, control unit 129 comprises logic control circuits, storage (e.g., memory), and a microprocessor. In a preferred approach, the control unit 129 is electrically coupled (e.g., via wire, cable, line, etc.) to the one or more magnetic read/write portions 121, for controlling operation thereof. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Read and write signals are communicated to and from read/write portions 121 by way of recording channel 125.

The above description of a typical magnetic disk storage system, and the accompanying illustration of FIG. 1 is for representation purposes only. It should be apparent that disk storage systems may contain a large number of disks and actuators, and each actuator may support a number of sliders.

An interface may also be provided for communication between the disk drive and a host (integral or external) to send and receive the data and for controlling the operation of the disk drive and communicating the status of the disk drive to the host, all as will be understood by those of skill in the art.

In a typical head, an inductive write portion includes a coil layer embedded in one or more insulation layers (insulation stack), the insulation stack being located between first and second pole piece layers. A gap is formed between the first and second pole piece layers by a gap layer at an air bearing surface (ABS) of the write portion. The pole piece layers may be connected at a back gap. Currents are conducted through the coil layer, which produce magnetic fields in the pole pieces. The magnetic fields fringe across the gap at the ABS for the purpose of writing bits of magnetic field information in tracks on moving media, such as in circular tracks on a rotating magnetic disk.

The second pole piece layer has a pole tip portion which extends from the ABS to a flare point and a yoke portion which extends from the flare point to the back gap. The flare point is where the second pole piece begins to widen (flare) to form the yoke. The placement of the flare point directly affects the magnitude of the magnetic field produced to write information on the recording medium.

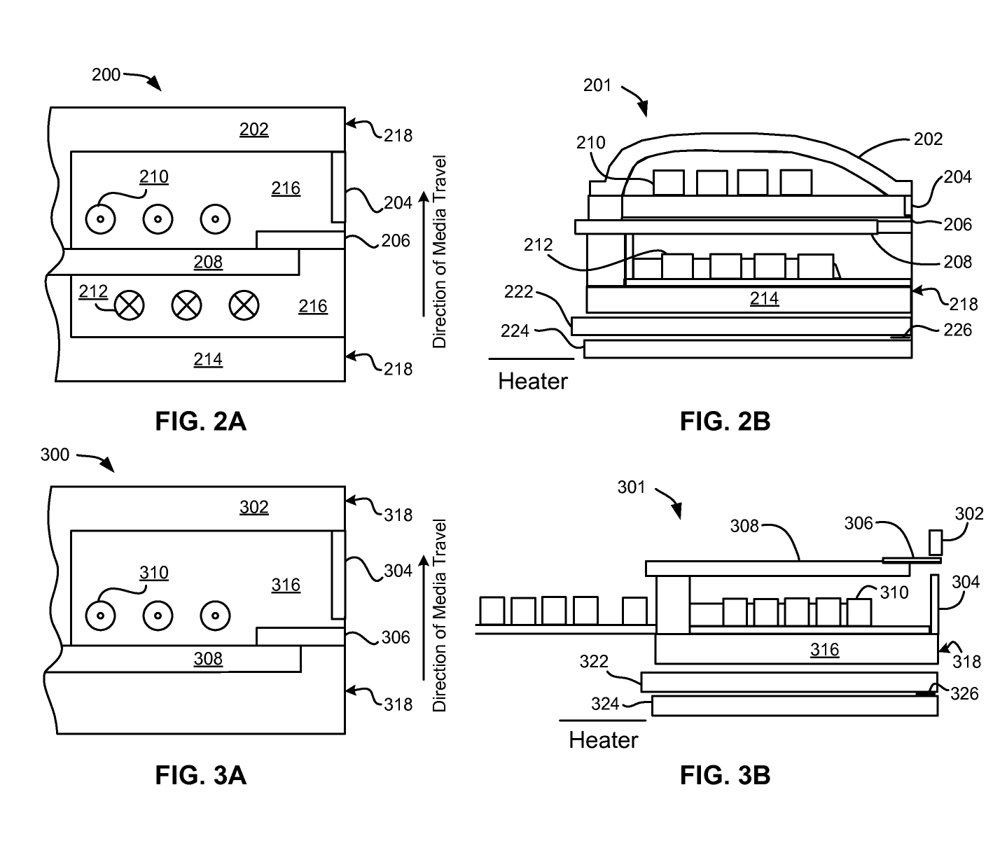

FIG. 2A is a cross-sectional view of a perpendicular magnetic head 200, according to one embodiment. In FIG. 2A, helical coils 210 and 212 are used to create magnetic flux in the stitch pole 208, which then delivers that flux to the main pole 206. Coils 210 indicate coils extending out from the page, while coils 212 indicate coils extending into the page. Stitch pole 208 may be recessed from the ABS 218. Insulation 216 surrounds the coils and may provide support for some of the elements. The direction of the media travel, as indicated by the arrow to the right of the structure, moves the media past the lower return pole 214 first, then past the stitch pole 208, main pole 206, trailing shield 204 which may be connected to the wrap around shield (not shown), and finally past the upper return pole 202. Each of these components may have a portion in contact with the ABS 218. The ABS 218 is indicated across the right side of the structure.

Perpendicular writing is achieved by forcing flux through the stitch pole 208 into the main pole 206 and then to the surface of the disk positioned towards the ABS 218.

In approaches that utilize a perpendicular magnetic head, such as the perpendicular magnetic head 200 shown in FIG. 2A, which may include a wraparound shield formed around the main pole, it may be possible to improve the overwrite characteristics while maintaining high medium SNR, and specifically to achieve operation at 140 Gb per square cm with a linear recording density per cm of 799 000 bits and a track density per cm of 175 000 tracks.

FIG. 2B illustrates one embodiment of a piggyback magnetic head 201 having similar features to the head 200 of FIG. 2A. As shown in FIG. 2B, two shields 204, 214 flank the stitch pole 208 and main pole 206. Also sensor shields 222, 224 are shown. The sensor 226 is typically positioned between the sensor shields 222, 224.

FIG. 3A is a schematic diagram of another embodiment of a perpendicular magnetic head 300, which uses looped coils 310 to provide flux to the stitch pole 308, a configuration that is sometimes referred to as a pancake configuration. The stitch pole 308 provides the flux to the main pole 306. With this arrangement, the lower return pole may be optional. Insulation 316 surrounds the coils 310, and may provide support for the stitch pole 308 and main pole 306. The stitch pole may be recessed from the ABS 318. The direction of the media travel, as indicated by the arrow to the right of the structure, moves the media past the stitch pole 308, main pole 306, trailing shield 304 which may be connected to the wrap around shield (not shown), and finally past the upper return pole 302 (all of which may or may not have a portion in contact with the ABS 318). The ABS 318 is indicated across the right side of the structure. The trailing shield 304 may be in contact with the main pole 306 in some embodiments.

FIG. 3B illustrates another embodiment of a piggyback magnetic head 301 having similar features to the head 300 of FIG. 3A. As shown in FIG. 3B, the piggyback magnetic head 301 also includes a looped coil 310, which wraps around to form a pancake coil. Sensor shields 322, 324 are additionally shown. The sensor 326 is typically positioned between the sensor shields 322, 324.

In FIGS. 2B and 3B, an optional heater is shown near the non-ABS side of the magnetic head. A heater (Heater) may also be included in the magnetic heads shown in FIGS. 2A and 3A. The position of this heater may vary based on design parameters such as where the protrusion is desired, coefficients of thermal expansion of the surrounding layers, etc.

In approaches that utilize a perpendicular magnetic head, such as the those shown in FIGS. 2A-3B, which may include a wraparound shield formed around the main pole, it may be possible to improve the overwrite characteristics while maintaining high medium SNR, and specifically to achieve operation at 140 Gb per square cm with a linear recording density per cm of 799 000 bits and a track density per cm of 175 000 tracks, or higher.

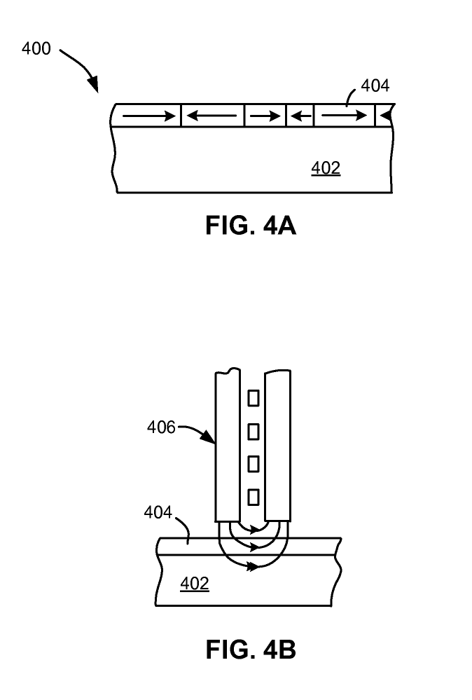

FIG. 4A provides a schematic illustration of a longitudinal recording medium 400 typically used with magnetic disk recording systems, such as that shown in FIG. 1. This longitudinal recording medium 400 is utilized for recording magnetic impulses in (or parallel to) the plane of the medium itself. This longitudinal recording medium 400, which may be a recording disk in various approaches, comprises at least a supporting substrate 402 of a suitable non-magnetic material such as glass, and a conventional magnetic recording layer 404 positioned above the substrate.

FIG. 4B shows the operative relationship between a recording/playback head 406, which may preferably be a thin film head and/or other suitable head as would be recognized by one having skill in the art upon reading the present disclosure, and the longitudinal recording medium 400 of FIG. 4A.

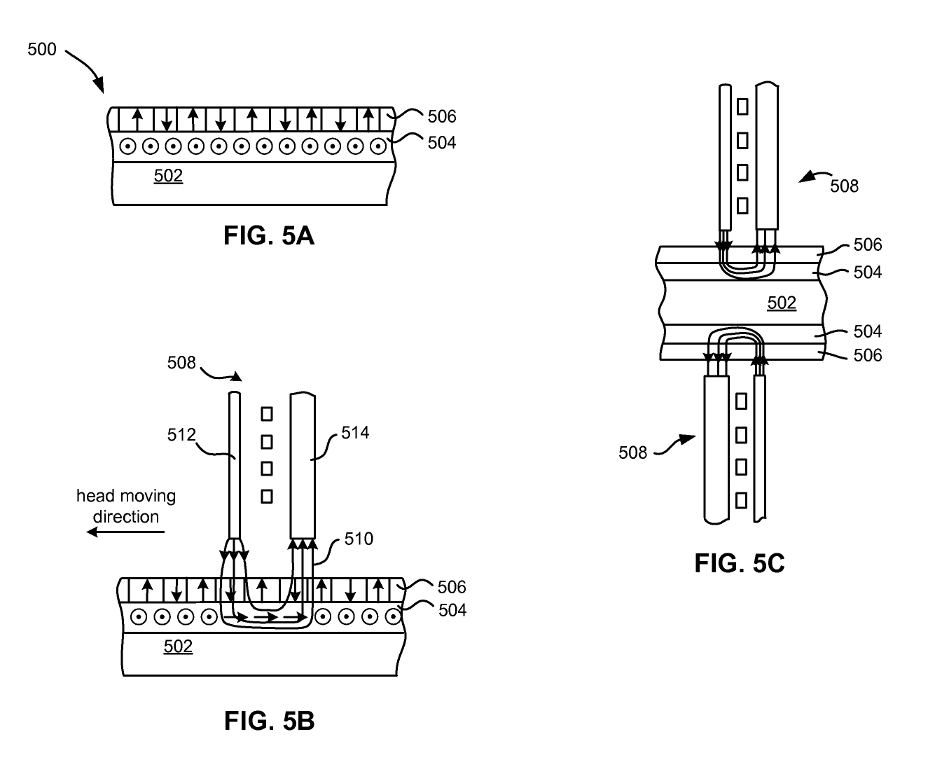

Improvements in longitudinal recording media have been limited due to issues associated with thermal stability and recording field strength. Accordingly, pursuant to the current push to increase the areal recording density of recording media, perpendicular recording media (PMR) has been developed. FIG. 5A provides a schematic diagram of a simplified perpendicular recording medium 500, which may also be used with magnetic disk recording systems, such as that shown in FIG. 1. As shown in FIG. 5A, the perpendicular recording medium 500, which may be a recording disk in various approaches, comprises at least a supporting substrate 502 of a suitable non-magnetic material (e.g., glass, aluminum, etc.), and a soft magnetic underlayer 504 of a material having a high magnetic permeability positioned above the substrate 502. The perpendicular recording medium 500 also includes a magnetic recording layer 506 positioned above the soft magnetic underlayer 504, where the magnetic recording layer 506 preferably has a high coercivity relative to the soft magnetic underlayer 504. There may one or more additional layers (not shown), such as an “exchange-break” layer or “interlayer”, between the soft magnetic underlayer 504 and the magnetic recording layer 506.

The orientation of magnetic impulses in the magnetic recording layer 506 is substantially perpendicular to the surface of the recording layer. The magnetization of the soft magnetic underlayer 504 is oriented in (or parallel to) the plane of the soft underlayer 504. As particularly shown in FIG. 5A, the in-plane magnetization of the soft magnetic underlayer 504 may be represented by an arrow extending into the paper.

FIG. 5B illustrates the operative relationship between a perpendicular head 508 and the perpendicular recording medium 500 of in FIG. 5A. As shown in FIG. 5A, the magnetic flux 510, which extends between the main pole 512 and return pole 514 of the perpendicular head 508, loops into and out of the magnetic recording layer 506 and soft magnetic underlayer 504. The soft magnetic underlayer 504 helps focus the magnetic flux 510 from the perpendicular head 508 into the magnetic recording layer 506 in a direction generally perpendicular to the surface of the magnetic medium. Accordingly, the intense magnetic field generated between the perpendicular head 508 and the soft magnetic underlayer 504, enables information to be recorded in the magnetic recording layer 506. The magnetic flux is further channeled by the soft magnetic underlayer 504 back to the return pole 514 of the head 508.

As noted above, the magnetization of the soft magnetic underlayer 504 is oriented in (parallel to) the plane of the soft magnetic underlayer 504, and may represented by an arrow extending into the paper. However, as shown in FIG. 5B, this in plane magnetization of the soft magnetic underlayer 504 may rotate in regions that are exposed to the magnetic flux 510.

FIG. 5C illustrates one embodiment of the structure shown in FIG. 5B, where soft magnetic underlayers 504 and magnetic recording layers 506 are positioned on opposite sides of the substrate 502, along with suitable recording heads 508 positioned adjacent the outer surface of the magnetic recording layers 506, thereby allowing recording on each side of the medium.

Except as otherwise described herein with reference to the various inventive embodiments, the various components of the structures of FIGS. 1-5B, and of other embodiments disclosed herein, may be of conventional material(s), design, and/or fabricated using conventional techniques, as would be understood by one skilled in the art upon reading the present disclosure.

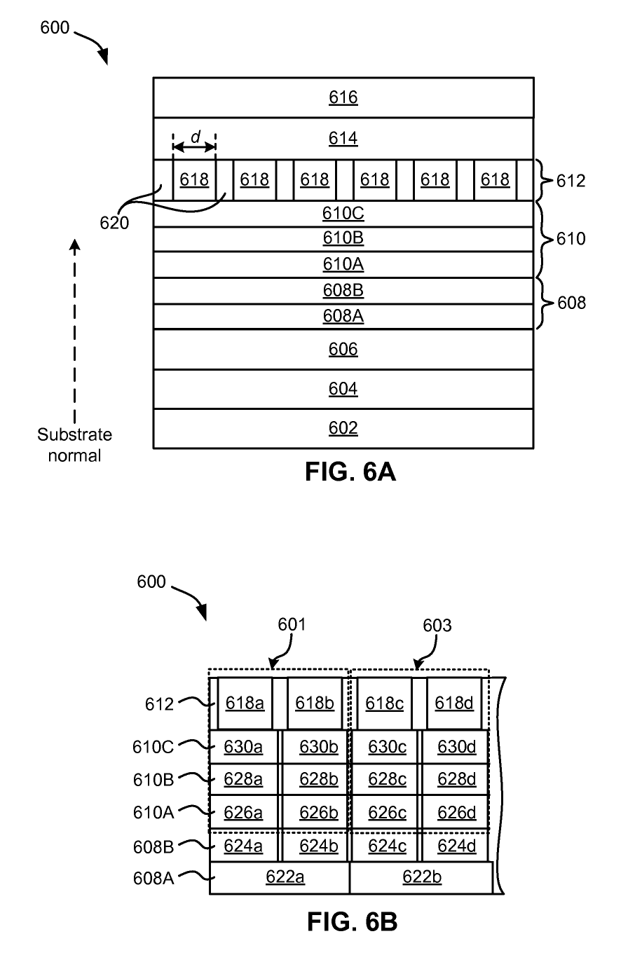

Referring now to FIGS. 6A-6B, portions of a perpendicular magnetic recording medium 600 are shown according to one embodiment. The perpendicular magnetic recording medium 600 includes several layers sequentially formed on a substrate 602, including an adhesion layer 604, a soft magnetic underlayer 606, a seed layer structure 608, an interlayer structure 610, a magnetic recording layer 612, a protective overcoat layer 614, and a lubricant layer 616.

As an option, the perpendicular magnetic recording medium 600 may be implemented in conjunction with features from any other embodiment listed herein, such as those described with reference to the other FIGS. Of course, the perpendicular magnetic recording medium 600 and others presented herein may be used in various applications and/or in permutations which may or may not be specifically described in the illustrative embodiments listed herein. For instance, various embodiments of the perpendicular magnetic medium 600 may include more or less layers than those shown in FIGS. 6A-6B. Further, the perpendicular magnetic recording medium 600 and others presented herein may be used in any desired environment.

As shown in the embodiment depicted in FIG. 6A, the perpendicular magnetic recording medium 600 includes a substrate layer 602 comprising a material of high rigidity, such as glass, Al, Al₂O₃, MgO, Si, plastics, or other suitable substrate material as would be understood by one having skill in the art upon reading the present disclosure.

As also shown in FIG. 6A, an adhesion layer 604 is present above the substrate layer 602. The adhesion layer 604 is configured to improve adhesion between the substrate 602 and the layers deposited thereon. In preferred approaches, the adhesion layer 604 comprises an amorphous material that does not affect the crystal orientation of the layers deposited thereon. Suitable materials for the adhesion layer 604 include, but are not limited to, Ni, Co, Al, Ti, Cr, Zr, Ta, Nb and combinations and/or alloys thereof. In particular approaches, the adhesion layer 604 includes at least one of TiAl, NiTa, TiCr, AlCr, NiTaZr, CoNbZr, TiAlCr, NiAlTi, CoAlTi, etc., or other suitable material as would be understood by one having skill in the art upon reading the present disclosure.

The thickness of the adhesion layer 604 is preferably in a range between about 2 nm to about 30 nm. If the thickness of the adhesion layer 604 is less than about 2 nm, the adhesive effect of the adhesion layer 604 may be poor, whereas a thickness greater than about 30 nm reveals no significant improvement in performance yet reduces the reducibility thereof, which is undesirable. As used herein, the thickness of a given layer in the perpendicular magnetic recording medium 600 is measured along the substrate normal (i.e., a direction perpendicular to the plane of the substrate 602, as indicated by the dotted arrow in FIG. 6A).

As further shown in FIG. 6A, a soft magnetic underlayer 606 is present above the adhesion layer 604. The soft magnetic underlayer 606 is configured to promote data recording in the magnetic recording layer 612 by suppressing the spread of the magnetic field and efficiently magnetizing the magnetic recording layer 612. In preferred approaches, the soft magnetic underlayer 606 has one or more of the following: a saturation magnetic flux density (Bs) of about 1 Tesla or less; uniaxial anisotropy in the radial direction (i.e., in-plane direction) of the soft magnetic underlayer 606; a coercive force of about 2.4 kA/m or less, as measured in the recording head direction; and excellent surface planarity. Suitable materials for the soft magnetic underlayer 606 include, but are not limited to, amorphous alloys including Co and/or Fe as the main component, with at least one of: Ta, Hf, Nb, Si, Zr, B, C, Cr, etc. added thereto.

The optimum thickness of the soft magnetic underlayer 606 may depend on the material(s) of the soft magnetic underlayer 606, the structure and material(s) of the magnetic head configured to apply a magnetic field to the perpendicular magnetic recording medium 600, and/or the distance between the soft magnetic underlayer 606 and the magnetic recording layer 612, in various approaches. However, a thickness of the soft magnetic underlayer 606 may be in a range between about 10 nm to about 50 nm, according to preferred approaches. In approaches where the thickness of the soft magnetic underlayer 606 is less than 10 nm, the magnetic flux from the magnetic head may not be adequately absorbed, and the resulting write-ability may be unsatisfactory. Conversely, in approaches where of the soft magnetic underlayer 606 is greater than 50 nm, the magnetic flux from the magnetic head may be broadened, and the resulting magnetic track width may be too wide to realize superior read-write performance at high-density recording.

In some approaches, the soft magnetic underlayer 606 may include a single layer structure or a multilayer structure. For instance, one example of a multilayer soft magnetic underlayer structure may include a coupling layer (e.g., including Ru) sandwiched between one or more soft magnetic underlayers, where the coupling layer is configured to induce an anti-ferromagnetic coupling between the one or more soft magnetic underlayers.

As additionally shown in FIG. 6A, a seed layer structure 608 is positioned above the soft magnetic underlayer 606. The seed layer structure 608 includes a first seed layer 608A and a second seed layer 608B positioned above the first seed layer 608A.

The first seed layer 608A is configured to control the crystalline orientation of the second seed layer 608B, as well as to control the grain size and crystalline orientation of the layers present within the interlayer structure 610 and/or the magnetic recording layer 612. To achieve such control of the crystalline orientation and/or grain size of layers positioned thereabove, the first seed layer 608A preferably includes a non-magnetic material having a face-centered cubic (fcc) structure. For example, in particular approaches, the first seed layer 608A includes Cu, Pd, Pt, Ni, etc., and/or alloys thereof, as these materials have an fcc structure. In preferred approaches, the first seed layer 608A includes a Ni-alloy. In more approaches where the first seed layer 608A includes an alloy of Cu, Pd, Pt, and/or Ni, the crystalline orientation of the seed layer 608A, as well as those formed thereabove, may be improved by adding at least one of the following alloying elements to the first seed layer 608A: Cr, W, V, Mo, Ta, Nb, etc., and other suitable alloying element as would be recognized by one skilled in the art upon reading the present disclosure. In more approaches, the first seed layer 608A does not include an oxide, and thus may also be referred to herein as the “non-oxide” seed layer.

The optimum thickness of the first seed layer 608A may depend on the material(s) and thickness of the layers present within the interlayer structure 610, the material(s) and thickness of the magnetic recording layer 612, and/or the structure and material of the magnetic head configured to apply a magnetic field to the perpendicular magnetic recording medium 600, in various approaches. However, a thickness of the first seed layer 608A may be in a range between about 2 nm to about 7 nm, according to preferred approaches. The crystalline orientation of the first seed layer 608A, as well as layers formed thereabove, may deteriorate in approaches where the thickness of the first seed layer 608A is less than 2 nm. Moreover, in approaches where the thickness of the first seed layer 608A is greater than 7 nm, the crystal grain size of the ferromagnetic grains 618 in the magnetic recording layer 612 may undesirably increase.

The second seed layer 608B shown in FIG. 6A is configured to promote the separation of the ferromagnetic grains 618 in the magnetic recording layer 612 without varying the size of said ferromagnetic grains 618. In various approaches, the second seed layer 608B preferably includes a non-magnetic material having an fcc structure. For example, in particular approaches, the second seed layer 608B may include Cu, Pd, Pt, Ni, etc., and/or alloys thereof, as these materials have an fcc structure. In preferred approaches, the second seed layer 608B includes a Ni-alloy. In more approaches where the second seed layer 608B includes an alloy of Cu, Pd, Pt, and/or Ni, the crystalline orientation of the second seed layer 608B, as well as those formed thereabove, may be improved by adding at least one of the following alloying elements to the second seed layer 608B: Cr, W, V, Mo, Ta, Nb, etc., and other suitable alloying element as would be recognized by one skilled in the art upon reading the present disclosure.

In addition to the at least one alloying element, the second seed layer 608B may also include at least one oxide to improve crystalline orientation, where the at least one oxide includes WO₃, Sift, TiO₂, Ti₂O₅, etc. In preferred approaches, a total oxide content in the second oxide layer 608B may be in a range between about 5 vol % to about 20 vol % based on the total volume of the second seed layer 608B. The ability of the second seed layer 608B to promote the separation of the ferromagnetic grains 618 in the magnetic recording layer 612 may be undesirably reduced in approaches where the second seed layer 608 has a an oxide content that is less than 5 vol %. Moreover, the crystalline orientation of the second seed layer 608B, as well as layers formed thereabove, may undesirably deteriorate in approaches where the oxide content in the second seed layer 608B is greater than 20 vol %. As the second seed layer 608B preferably includes at least one oxide, it may be referred to herein in various approaches as the “oxide seed layer”.

In numerous approaches, the second seed layer 608B has a thickness in a range between about 1 nm to about 4 nm. The ability of the second seed layer 608B to promote the separation of the ferromagnetic grains 618 in the magnetic recording layer 612 may be undesirably reduced in approaches where the second seed layer 608 has a thickness less than 1 nm. However, the crystalline orientation of the second seed layer 608B, as well as layers formed thereabove, may undesirably deteriorate in approaches where the thickness of the second seed layer 608B is greater than 4 nm.

It is important to note while the seed layer structure 608 structure shown in FIG. 6A includes both the first seed layer 608A and the second seed layer 608B, the seed layer structure may include only the first seed layer 608A or only the second seed layer 608B in some approaches. However, in approaches where the seed layer structure 608 includes only the second seed layer 608B and the second seed layer is positioned directly on the soft magnetic underlayer 606, the crystalline orientation of the second seed layer 608B, as well as layers formed thereabove, may undesirably deteriorate. Accordingly, in approaches where the second seed layer 608B is present within the seed layer structure 608, it is preferable that the first seed layer 608A is also present therein and positioned between the second seed layer 608B and the soft magnetic underlayer 606.

With continued reference to FIG. 6A, the interlayer structure 610 is positioned above the seed layer structure 608. The interlayer structure 610 includes a first interlayer 610A, a second interlayer 610B positioned above the first interlayer 610A, and a third interlayer 610C positioned above the second interlayer 610B.

The first interlayer 610A is configured to improve the crystalline orientation of the second and third interlayers 610B, 610C, as well as improve the crystalline orientation and/or the separation of the ferromagnetic grains 618 in the magnetic recording layer 612. In various approaches, the first interlayer 610A has a hexagonal close-packed (hcp) structure.

In particular approaches, the first interlayer 610A includes a Ru alloy having an hcp structure, where the Ru alloy includes one or more alloying elements selected from a group consisting of: Cr, Ta, W, Mo, Nb, V, and Co. In approaches where Cr is included in the Ru alloy, the Cr content therein may be in a range between about 10 at % to about 40 at %. In approaches where Ta is included in the Ru alloy, the Ta content therein may be in a range between at about 10 at % to about 20 at %. In approaches where W is included in the Ru alloy, the W content therein may be in a range between about 10 at % to about 40 at %. In approaches where Mo is included in the Ru alloy, the Mo content therein may be in a range between about 10 at % to about 50 at %. In approaches where Nb is included in the Ru alloy, the content of Nb therein may be in a range between about 10 at % to about 20 at %. In approaches where V is included in the Ru alloy, the content of V therein may be in a range between about 10 at % to about 30 at %. In approaches where Co is included in the Ru alloy, the content of Co therein may be in a range between about 10 at % to about 40 at %. The ability of the first interlayer 610A to promote grain separation in the magnetic recording layer 612 may be undesirably reduced in approaches where the content of the one or more alloying elements (e.g., Cr, Ta, W, Mo, Nb, V, and/or Co) in the first interlayer 610A is below about 10 at %. However, the crystalline orientation of the first interlayer 610A and layers formed thereabove may undesirably deteriorate in approaches where the content of any of the one or more alloying elements (e.g., Cr, Ta, W, Mo, Nb, V, and/or Co) in the first interlayer 610A exceed their respective upper limits (e.g., 40 at % for Cr; 20 at % for Ta; 40 at % for W; 50 at % for Mo; 20 at % Nb; 30 at % for V; and 40 at % for Co).

In some approaches the thickness of the first interlayer 610A may be in a range between about 2 nm to about 8 nm. The crystalline orientation of the first interlayer 610A and layers formed thereabove may undesirably deteriorate in approaches where the thickness of the first interlayer 610A is less than 2 nm. In approaches where the thickness of the first interlayer 610A is greater than 8 nm, the distance between the magnetic recording head and the soft magnetic underlayer 606 may increase, which in turn may increase the writing spread and make it more difficult to achieve high areal density recording. Moreover, inclusion of a Ru-alloy having at least one of: Cr, Ta, W, Mo, Nb, V, and Co, in the first interlayer 610A may reduce the melting point of the first interlayer 610A. Accordingly a thickness of the first interlayer 610A that is greater than 8 nm may lead to an undesirable increase in the crystal gain size of the magnetic recording layer 612.

The crystal grain size of the recording layer 612 is primarily controlled by the thickness of the first seed layer 608A; however, the average grain size of the first seed layer 608A is substantially greater than the average grain size of the magnetic recording layer 612. This is illustrated in FIG. 6B, which provides a close-up view of the crystal grains 618a-d of the magnetic recording layer 612, the crystal grains 622a-d, 624a-d of the first and second seed layers 608A, 608B, respectively, and the crystal grains 626a-d, 628a-d, 630a-d of the first, second, and third interlayers 610A, 610B, 610C, respectively. The plurality of crystal grains in each of these layers are separated by grain boundaries, which may include a non-magnetic and/or nonmetallic material.

As also shown in FIG. 6B, the crystal grains of the plurality of interlayers 610A-C and the magnetic recording layer 612 are grown on the crystal grains of first seed layer 608A. As such, each hcp-structured crystal grain in the magnetic recording layer 612 has an a-axis orientation that is substantially or perfectly aligned with the a-axis orientation of each of the hcp-structured crystal grains that are positioned directly below in the plurality of interlayers 610A, 610B, 610C.

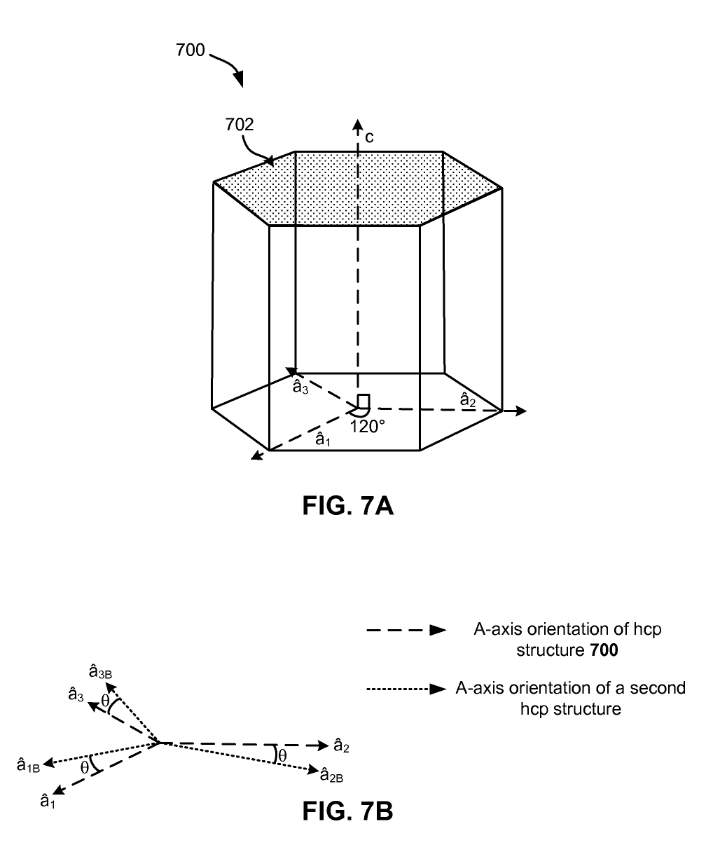

The a-axis orientation of a simplified, generic hcp structure 700 is shown in FIG. 7A. For example, as shown in FIG. 7A, the a-axis orientation of the hcp structure 700 may be represented by three vectors (a₁, a₂, a₃), which lie in a plane that is perpendicular to the c-axis. For perpendicular magnetic recording purposes, the c-axis of an hcp-structured ferromagnetic grain is preferably oriented in a perpendicular direction relative to the magnetic recording layer plane. In other words, the (0001) plane 702 is preferably oriented parallel to the magnetic recording layer plane. The a-axis orientation of the hcp structure 700 may be substantially aligned with the a-axis orientation of a second hcp structure when the a-axis orientation is rotated about the c-axis by less than or equal to about ±5 degrees, preferably less than or equal to about ±1 degrees, relative to the a-axis orientation of the second hcp structure. Such substantial a-axis orientation is illustrated in FIG. 7B, where the angle, θ, between the a-axis alignment (as represented by â₁, â₂, â₃) of the hcp structure 700 and the a-axis alignment (as represented by â_{1B}, â_{2B}, â_{3B}) of a second hcp structure is less than or equal to about ±5 degrees, preferably less than or equal to about ±1 degrees. The a-axis orientation of the hcp structure 700 may be perfectly aligned with the a-axis orientation of the second hcp structure in instances where the angle, θ, is 0 degrees.

FIG. 6B is again referenced in order to further explain the a-axis orientation alignment of the grains in the magnetic recording layer 612 and the plurality of interlayers 610A, 610B, 610C. For illustration purposes only, reference is made to the dotted box 601 in FIG. 6B, which surrounds the crystal grains in the magnetic recording layer 612 and the plurality of interlayers 610A, 610B, 610C that are grown above the crystal grain 622a in the first seed layer 608A. The a-axis orientations of the crystal grains 618a-b, 630a-b, 628a-b, 626a-b, which are grown above the crystal grain 622a, may be substantially aligned relative to one another. In preferred approaches, the a-axis orientations of the crystal grains 618a-b, 630a-b, 628a-b, 626a-b may be perfectly aligned relative to one another. Moreover, the c-axis orientations of the crystal grains 618a-b, 630a-b, 628a-b, 626a-b may also be aligned relative to another and preferably oriented substantially parallel to the substrate normal (i.e., within ±10 degrees of the substrate normal). The crystal grains 618a and 618b of the magnetic recording layer 612 form a first crystalline cluster, as said grains have perfectly aligned or substantially aligned a-axis orientations. As used herein, the crystal grains of the magnetic recording layer 612 that have aligned or substantially aligned a-axis orientations relative to one another may be referred to as “crystalline clusters”.

Reference is also made to the dotted box 603 in FIG. 6B, which surrounds the crystal grains in the magnetic recording layer 612 and the plurality of interlayers 610A, 610B, 610C that are grown above the crystal grain 622b in the first seed layer 608A. The a-axis orientations of the crystal grains 618c-d, 630c-d, 628c-d, 626c-d, which are grown above the crystal grain 622b, may be substantially, or preferably perfectly, aligned relative to one another. Additionally, the c-axis orientations of the crystal grains 618c-d, 630c-d, 628c-d, 626c-d may also be aligned relative to another and preferably oriented substantially parallel to the substrate normal. The crystal grains 618c and 618d of the magnetic recording layer 612 form a second crystalline cluster, as said grains have aligned or substantially aligned a-axis orientations.

As noted above, the grains in the dotted box 601 are grown above the crystal grain 622a in the first seed layer 608A, whereas the grains in the dotted box 603 are grown above the crystal grain 622b in the first seed layer 608A. Accordingly, there may be no alignment between the a-axis orientation of the grains in the dotted box 601 (i.e., crystal grains 618a-b, 630a-b, 628a-b, 626a-b) and the grains in the dotted box 603 (i.e., 618c-d, 630c-d, 628c-d, 626c-d), in various approaches. Stated another way, the a-axis orientation of the grains in the dotted box 601 may not necessarily align with the a-axis orientations of the grains in the dotted box 603. 618c. For example, the a-axis orientation of crystal grain 618b may be perfectly or substantially aligned with crystal grain 618a, but not aligned with the a-axis orientation of crystal grain 618c. Accordingly, there may be no a-axis orientation alignment between at least two, some or all of the crystalline clusters present in the magnetic recording layer 612.

It is important to note, however, the c-axis orientation of each crystalline cluster in the magnetic recording layer 612 may preferably be aligned relative to one another and oriented substantially parallel to the substrate normal. For instance, the c-axes of the crystal grains 618a, 618b, 619c, and 618d may be perfectly or substantially aligned relative to one another and preferably oriented substantially parallel to the substrate normal.

In has been found in conventional magnetic recording layers that the width of the grain boundaries within crystalline clusters may be less than the width of the grain boundaries between crystalline clusters. Magnetic separation of the crystal grains within the crystalline clusters may thus be inadequate, thereby hindering noise reduction in conventional magnetic recording layers. Magnetic separation of the crystal grains within and/or between the crystalline clusters may be improved by increasing the respective grain boundary widths. One approach to improve magnetic separation in a magnetic recording layer may involve increasing the oxide content in the magnetic recording layer; however, this may only increase the grain boundaries between the crystalline clusters (e.g., there will be no increase in the magnetic separation of the grains within the crystalline clusters). Another approach to improve magnetic separation in a magnetic recording layer, may involve reducing the size of the grains and/or the size of the crystalline clusters in the magnetic recording layer. One effective way to reduce the grain size and/or the crystalline cluster of a magnetic recording layer may involve reducing the grain size of a seed layer positioned below the magnetic recording layer; however, this may lead to an undesirable deterioration in the crystalline orientation of the layers formed above the seed layer. For instance, an undesirable deterioration in the crystalline orientation may refer to a deterioration in the c-axis orientation, which is preferably oriented perpendicular to the magnetic recording layer plane.

With continued reference to the embodiment illustrated in FIG. 6A, the inventors have surprisingly and unexpectedly found that, in particular approaches, the size of the grains and/or the crystalline clusters in the magnetic recording layer 612 may be reduced without negatively affecting (e.g., deteriorating) the crystalline orientation thereof by forming the magnetic recording layer 612 above at least: a first seed layer 608A having an Ni alloy; a second seed layer 608B having a Ni alloy and at least one oxide; and a first interlayer 610A having a Ru alloy and one or more additional alloying elements that possess a higher standard free energy of formation relative to Ru. In such approaches, the crystal grains of the first seed layer 608A have an fcc structure with the (111) plane oriented substantially parallel to the plane of the substrate 602, and the crystal grains of the first interlayer 610A has a hcp structure with the (0001) plane oriented substantially parallel to the plane of the substrate 602. Thus, while the crystal structures of the grains in the first seed layer 608A and the first interlayer 610A are different, the (111) plane of the fcc structure and the (0001) plane of the hcp structure have the same atomic arrangement in the two-dimensional lattice, thereby promoting good epitaxial growth when lamination takes place. Consequently, each hcp-structured crystal grain in the plurality of interlayers 610A-C may have an a-axis orientation that is substantially aligned with the a-axis orientation of the hcp-structured interlayer grain that is positioned directly above and/or below. The plurality of interlayers 610A-C and the magnetic recording layer 612 each have grains with hcp structures, the a-axis orientations of which do not change at the magnetic recording layer/interlayer interface. For instance, at the magnetic recording layer/interlayer interface, each hcp-structured crystal grain in the magnetic recording layer 612 may have an a-axis orientation that is substantially aligned with the a-axis orientation of the hcp-structured interlayer crystal grain that is positioned directly below. Crystalline clusters are therefore formed in the magnetic recording layer 612 for this reason.

In the approaches described directly above, a reaction may take place at the interface between the second seed layer 608B having a Ni alloy and at least one oxide, and the first interlayer 610A having a Ru alloy and one or more additional alloying elements that possess a higher standard free energy of formation relative to Ru. This reaction may disrupt the a-axis orientation of the first interlayer 610A, which may ultimately reduce the crystalline cluster size in the magnetic recording layer 612. As there is a correlation between the crystalline cluster size and the magnetic cluster size (discussed in greater detail in the Examples below), a reduction in the crystalline cluster size may also result in a reduction in the magnetic cluster size.

Referring again to FIG. 6A, the perpendicular magnetic recording medium 600 includes a second interlayer 610B positioned above the first interlayer 610A. The second interlayer 610B is configured to promote magnetic separation of the ferromagnetic grains 618 in the magnetic recording layer 612. In various approaches, the second interlayer 610B includes Ru or a Ru-based alloy having an hcp structure. In more approaches, the second interlayer 610B has a higher Ru content than the first interlayer 610A.

The second interlayer 610B may preferably formed at a high gas pressure to promote magnetic separation of the ferromagnetic grains 618 in the magnetic recording layer 612. In particular approaches, the second interlayer 610B may be formed at gas pressure of at least about 2 Pa. By forming the second interlayer 610B at such high gas pressures, the surface roughness of Ru may increase, thereby increasing the isolation of Ru grains, which may in turn may promote magnetic separation of the ferromagnetic grains 618 in the magnetic recording layer 612.

In some approaches, the second interlayer 610B may include a Ru alloy with at least one of the following elements Cr, Ta, W, Mo, Nb, V, and Co. It may be disadvantageous to add a large amount of these elements, as this may reduce the melting point and surface energy of the Ru alloy, making it difficult to form the required structure.

In additional approaches, the thickness of the second interlayer 610B may be in a range between about 4 nm to about 14 nm, preferably in a range between about 6 nm to about 12 nm.

As also shown in FIG. 6A, the third interlayer 610C is positioned above the second interlayer 610B. The third interlayer 610C is configured to promote the magnetic separation of the ferromagnetic grains 618 in the magnetic recording layer 612. In various approaches, the third interlayer 610C comprises Ru as the primary component. For instance, the Ru content in the third interlayer 610C may be in a range between about 50 at % to about 80 at %.

In addition to Ru, the third interlayer 610C may also include one or more of the following additional elements: Ti, Nb, Al, Ta, and Si, in more approaches. In still more approaches, the composition of the third interlayer 610C has an hcp structure and another structure. Accordingly, to achieve a composition having an hcp structure and another structure, the content of the Ru and the additional elements added thereto should fall within particular ranges. For example, in approaches where the third interlayer 610C comprises a RuTi alloy, the Ti may be present in an amount ranging from about 20 at % to about 50 at %. In approaches where the third interlayer 610C comprises a RuNb alloy, the Nb may be present in an amount ranging from about 20 at % to about 50 at %. In approaches where the third interlayer 610C comprises a RuAl alloy, the Al may be present in an amount ranging from about 20 at % to about 40 at %. In approaches where the third interlayer 610C comprises a RuTa alloy, the Ta may be present in an amount ranging from about 30 at % to about 50 at %. In approaches where the third interlayer 610C comprises a RuSi alloy, the Si may be present in an amount ranging from about 20 at % to about 40 at %. These specified ranges corresponding to the amount of the element(s) that may be added to Ru correspond to the ranges for which the hcp structure and the other crystal structure are combined in accordance with a secondary state diagram of Ru and the additional element(s). If the amount of the additional element(s) is below the aforementioned ranges, there may be reduction in the third interlayer's 610C ability to promote magnetic separation of the ferromagnetic grains 618 in the magnetic recording layer 612. However, if the amount of the additional element(s) is above the aforementioned ranges, there may be excessive promotion of magnetic grain separation in the magnetic recording layer 612 and thus formation of a large amount of refined (e.g., smaller) grains in the magnetic recording layer 612, which may in turn result in undesirable thermal instability.

In further approaches, the third interlayer 610C may include Ru and at least one oxide. The additional of an oxide to the third interlayer 610C may further promote the magnetic separation of the ferromagnetic grains 618 in the magnetic recording layer 612. In yet more approaches, the third interlayer 610C may include Ru and at least one oxide and/or at least one of the following elements: Ti, Nb, Al, Ta, and Si. In approaches where at least one oxide is included in the third interlayer 610C, the oxide content therein may correspond to whichever is lower: (1) an oxide amount that is equal to or less than half the amount of the additional element(s) (e.g., Ti, Nb, Al, Ta, and Si); or (2) an oxide amount that is less than or equal to about 40 vol % based on the total volume of the third interlayer 610C.

According to still more approaches, the third interlayer 610C may have a thickness in a range between about 0.5 nm and about 2 nm. In approaches where the thickness of the third interlayer 610C may have a thickness below about 0.5 nm, the effect of promoting magnetic separation of the ferromagnetic grains 618 in the magnetic recording layer 612 may not be achieved. However, in approaches where the thickness of the third interlayer 610C may have a thickness above about 2 nm, there may be an undesirable deterioration in the crystalline orientation of the magnetic recording layer 612.

As additionally shown in FIG. 6A, the magnetic recording layer 612 is positioned above the third interlayer 610C. As discussed previously, the magnetic recording layer 612 (also referred to in some approaches as the granular magnetic recording layer 612) includes a plurality of ferromagnetic grains 618 which are separated from one another via non-magnetic grain boundaries 620. The ferromagnetic material of the grains 618 may include, but is not limited to, Cr, Fe. Ta, Ni, Mo, Pt, W, Cr Ru, Ti, Si, O, V, Nb, Ge, B, Pd. In some approaches, the ferromagnetic grains 618 may include alloys comprising with Co and Pt as the main components. An average diameter, d, of the ferromagnetic grains 618 may preferably be in a range between about 5 nm to about 11 nm, but could be higher or lower depending on the desired embodiment. In more approaches, at least one oxide and/or nitride of Si, Ti Ta, B, Cr, W and Nb may be present in at the non-magnetic grain boundaries 620.

In various approaches, the magnetic recording layer 612 may include multiple layers. Each of these magnetic recording layers, if present, may also include a plurality of magnetic grains separated by non-magnetic grain boundaries, where the magnetic grains and the oxide(s) and/or nitride(s) present at the non-magnetic grain boundaries may include any of the suitable materials, compositions and/or structures disclosed herein. In particular approaches, it may be possible to improve the overwrite characteristics while maintaining low noise by forming multiple magnetic recording layers where at least one, some or all of the magnetic recording layers have a different Pt amount, a different amount of the added elements (e.g., Cr, Ti, Ta, Ru, W, Mo, Cu, B, Co, etc.), and/or a different amount of at least one oxide and/o nitride of Si, Ti, Ta, B, Cr, W and Nb.

In other approaches, a non-granular magnetic recording layer (not shown in FIG. 6A) may be positioned above the magnetic recording layer 612 (and additional multiple granular magnetic recording layers if present) and below the protective overcoat layer 614. The presence of such a non-granular magnetic recording layer above the magnetic recording layer 612 may further improve overwrite characteristics. In a preferred approach, a non-granular layer may include a CoCrPt as the primary component and at least one element selected from B, Ta, Ru, Ti, W, Mo, and Nb.

The composition and film thickness of the magnetic recording layer(s) described above may be adjusted to match a film thickness of the soft magnetic underlayer 606 and/or the performance of the magnetic head. There are no particular restrictions on the composition and film thickness of said magnetic recording layer(s) provided that thermal resistance and demagnetization characteristics can be maintained.

A protective overcoat layer 614 is positioned above the magnetic recording layer 612, as shown in FIG. 6A. The protective overcoat layer 614 may be configured to protect the underlying layers from wear, corrosion, etc. This protective overcoat layer 614 may be made of diamond-like carbon, carbon nitride, Si-nitride, BN or B4C, etc. or other such materials suitable for a protective overcoat as would be understood by one having skill in the art upon reading the present disclosure. In preferred approaches, a thickness of the protective overcoat layer 614 may be in a range between about 2 nm to about 4 nm.

A lubricant layer 616 may be positioned above the protective overcoat layer 614, as also shown in FIG. 6A. The material of the lubricant layer 616 may include, but is not limited to, a perfluoroalkyl polyether, fluorinated alcohol, fluorinated carboxylic acids, etc., or other suitable lubricant material as known in the art.

The formation of the layers in the perpendicular magnetic recording medium 600 may be achieved via known deposition and processing techniques, such as DC magnetron sputtering, RF magnetron sputtering, molecular beam epitaxy, etc. Among these techniques, sputtering deposition techniques have been used for mass production purposes due to its relatively high film formation speed and capacity to control the fine structure and the distribution of film thickness of a thin film.

### ILLUSTRATIVE EMBODIMENTS AND COMPARATIVE EXAMPLES

The following illustrative embodiments describe the novel magnetic media disclosed herein, particularly those which achieve high areal densities, low noise and reduced magnetic cluster sizes without an increase in the magnetic recording layer oxide content. Comparative examples are also provided to illustrate the differences between conventional magnetic media and the illustrative embodiments of the novel magnetic media disclosed herein. It is important to note that the following illustrative embodiments do not limit the invention in anyway. It should also be understood that variations and modifications of these illustrative embodiments may be made by those skilled in the art without departing from the spirit and scope of the invention.

The perpendicular magnetic recording media described in the following illustrative embodiments and comparative examples were fabricated using a sputtering apparatus (200LEAN) produced by Intevac. This apparatus included a plurality of process chambers for film formation. Each of these process chambers were evacuated independently to a pressure of 2×10⁻⁵ Pa or lower, after which a carrier with a substrate mounted thereon was moved to each chamber in order to carry out successive processing. For each perpendicular magnetic recording medium, DC magnetron sputtering was used in order to form the following succession of layers above a substrate: soft magnetic underlayer(s), seed layer(s), interlayer(s), magnetic recording layers(s), and protective overcoat layer. A lubricant layer, including a perfluoroalkyl polyether-based material diluted with a fluorocarbon, was also applied above the protective overcoat layer.

### Illustrative Embodiment 1-1 vs. Comparative Examples 1-1 to 1-3

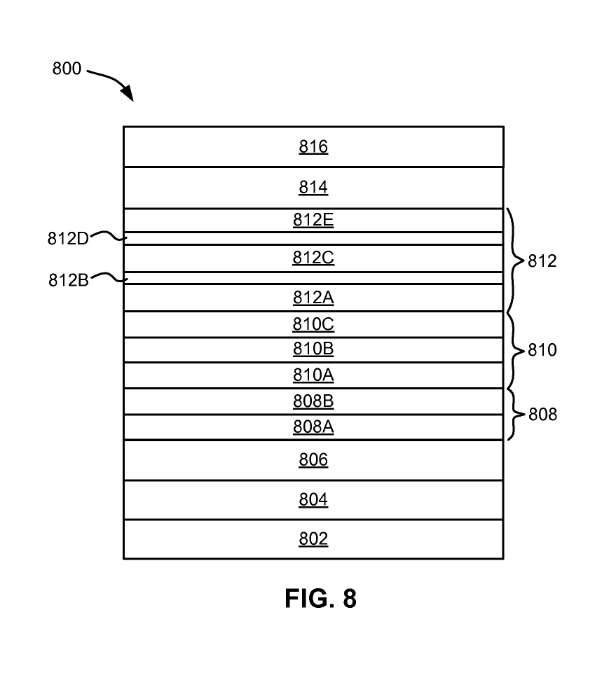

Illustrative Embodiment 1-1 corresponds to the perpendicular magnetic recording medium 800 shown in FIG. 8. The perpendicular magnetic recording medium 800 includes several layers sequentially formed on a substrate 802, including: an adhesion layer 804; a soft magnetic underlayer 806; a seed layer structure 808 having a first seed layer 808A, and a second seed layer 808B; an interlayer structuring 810 having a first interlayer 810A, a second interlayer 810B, and a third interlayer 810C; a magnetic recording layer 812 having a first recording layer 812A, a second recording layer 812B, a third recording layer 812C, a fourth recording layer 812D, and a fifth recording layer 812E; a protective overcoat layer 814, and a lubricant layer 816.

The substrate 802 was a glass substrate having a thickness of 0.8 mm and a diameter of 65 mm. Without heating the substrate and under an Ar gas pressure of 0.7 Pa, the following two layers were formed: the adhesion layer 804 having a thickness of 20 nm and Ni-37.5 at % Ta, and the soft magnetic underlayer 806 having an 0.4 nm Ru film interposed between an upper and lower Fe-29 at % Co-19 at % Ta alloy film.

The first seed layer 808A was formed to a thickness of 5 nm and included Ni-10 at % Cr-6 at % W. A target in which 3 mol % WO₃ was added to Ni-6 at % W was used to form the second seed layer 808B to a thickness of 2 nm.

The first interlayer 810A was formed to a thickness of 4 nm under an Ar gas pressure of 0.6 Pa and included Ru-30 at % Cr. The second interlayer 810B included Ru formed to a thickness of 4 nm under an Ar gas pressure of 2 Pa, and Ru formed to a thickness of 5 nm under an Ar gas pressure of 4.6 Pa. A target in which 10 mol % TiO₂ was added to Ru-30 at % Ti alloy was used to form the third interlayer 810C to a thickness of 0.7 nm under an Ar gas pressure 4 Pa.

A target in which 4 mol % Sift and 4 mol % TiO₂ were added to a Co-10 at % Cr-20 at % Pt alloy was used to form the first recording layer 812A to a thickness of 5 nm under a gas pressure of 4 Pa, where the gas comprised 0.5% oxygen with Ar gas. A target in which 6 mol % Sift was added to a Co-40 at % Cr alloy was used to form the second recording layer 812B to a thickness of 0.8 nm under an Ar gas pressure of 2 Pa. A target in which 3 mol % Sift and 3 mol % TiO₂ were added to a Co-22 at % Cr-14 at % Pt alloy was used to form the third recording layer 812C to a thickness of 5 nm under an Ar gas pressure of 3 Pa. A target in which 4 mol % Sift was added to a Co-30 at % Cr-10 at % Pt alloy was used to form the fourth recording layer 812D to a thickness of 0.5 nm under an Ar gas pressure of 1 Pa. A target comprising Co-16 at % Cr-14 at % Pt-7 at % B alloy was used to form the fifth recording layer 812E to a thickness of 4 nm under Ar gas pressure of 1 Pa.

A DLC film of thickness 2.6 nm was used to form the protective overcoat layer 814. As noted above, the lubricant layer 816 included a perfluoroalkyl polyether-based material diluted with a fluorocarbon.

Comparative Example 1-1 corresponds to a perpendicular magnetic recording medium that does not have the second seed layer 808B, but is otherwise identical to the perpendicular magnetic recording medium of Illustrative Embodiment 1-1. Comparative Example 1-2 corresponds to a perpendicular magnetic recording medium that has a first interlayer 810A consisting of only Ru, but is otherwise identical to the perpendicular magnetic recording medium of Illustrative Embodiment 1-1. Comparative Example 1-3 corresponds to a perpendicular magnetic recording medium that (i) does not have the second seed layer 808B and (ii) has a first interlayer 810A consisting of only Ru, but is otherwise identical to the perpendicular magnetic recording medium of Illustrative Embodiment 1-1.

A summary of the layers included in the magnetic media of Illustrative Embodiment 1-1, and Comparative Examples 1-1 is provided in Table 1, below.

TABLE 1

| 5th Recording | Co—16at%Cr—14at%Pt—7at%B | | | |
|---|---|---|---|---|
| Layer | | | | |
| 4th Recording | (Co—30at%Cr—10at%Pt)—4mol%SiO₂ | | | |
| Layer | | | | |
| 3rd Recording | (Co—22at%Cr—14at%Pt)—3mol%SiO₂—3mol%TiO₂ | | | |
| Layer | | | | |
| 2nd Recording | (Co—40at%Cr)—6mol%SiO₂ | | | |
| Layer | | | | |
| 1st Recording | (Co—10at%Cr—20at%Pt)—4mol%SiO₂—4mol%TiO₂ | | | |
| Layer | | | | |
| 3^{rd} Interlayer | (Ru—30at%Ti)— | (Ru—30at%Ti)— | (Ru—30at%Ti)— | (Ru—30at%Ti)— |
| | 10mol%TiO₂ | 10mol%TiO₂ | 10mol%TiO₂ | 10mol%TiO₂ |
| 2^{nd} Interlayer | Ru | Ru | Ru | Ru |
| 1^{st} Interlayer | Ru—30at%Cr | Ru—30at%Cr | Ru | Ru |
| 2^{nd} Seed Layer | (Ni—6at%W)— | — | (Ni—6at%W)— | — |
| | 3mol%WO₃ | | 3mol%WO₃ | |
| 1^{st} Seed Layer | Ni—10at%Cr— | Ni—10at%Cr— | Ni—10—at%Cr— | Ni—10at%Cr— |
| | 6at%W | 6at%W | 6at%W | 6at%W |
| | Ill. Emb. 1-1 | Comp. Ex. 1-1 | Comp. Ex. 1-2 | Comp. Ex. 1-3 |

A Kerr effect magnetometer was used to measure the magnetic characteristics of the media. While a magnetic field was applied in a direction perpendicular to the film surface of the sample, the Kerr rotational angle was detected and the Kerr loop was measured. The sweep of the magnetic field was a constant velocity, from +2000 kA/m to −2000 kA/m, then from −2000 kA/m to +2000 kA/m in a span of 30 seconds.

The magnetic cluster size in the recording layers of the media was obtained by analyzing the minor loops using a Kerr effect magnetometer. The details of this measurement means are described, for example, in H. Nemoto, et al., “Designing magnetic of capped perpendicular media with minor-loop analysis”, J. MMM, 320 (2008) 3144-3150. The saturation magnetization Ms value, which was measured using a vibrating sample magnetometer (VSM), was used to calibrate the absolute value of magnetization.

The crystalline orientation of the media was measured using a thin-film X-ray diffraction apparatus (RIGAKU, SmartLab). For each magnetic recording medium, this measurement involved first determining 2θ from the hcp (0004) diffraction peak of the recording layer by θ-2θ scanning, and then measuring the rocking curve. The crystal orientation (Δθ₅₀) of the media was thus determined from their respective rocking curves.

The recording/reproduction characteristics of the media were evaluated by means of a spin-stand. This particular evaluation employed a magnetic head including a recording element, which was of the single-pole type and had a track width of 55 nm, and a reproduction element, which utilized the tunnel magnetoresistance (TMR) effect and had a track width of 30 nm. Moreover, this conditions for this evaluation included a circumferential speed of 10 m/s, a skew angle of 0°, and magnetic spacing of approximately 6 nm. The medium SNR was specified as the ratio of the reproduction output when a signal of 10124 fr/mm was recorded to the integrated noise when a signal of 70867 fr/mm was recorded.

Table 2 shows the magnetic characteristics (coercive force Hc), the crystalline orientation (Δθ50) and SNR of the media corresponding to Illustrative Embodiment 1-1 and Comparative Examples 1-1 to 1-3.

TABLE 2

| | | 1st | Magnetic Recording Layer | | |
|---|---|---|---|---|---|
| | 2nd Seed | Intermediate | Hc | Δθ50 | SNR |
| | Layer | Layer | (kOe) | (deg.) | (dB) |
| Ill. | Ni—6at.%W— | Ru—30at.%Cr | 5.1 | 2.7 | 23.0 |
| Emb. | 3mol%WO₃ | | | | |
| 1-1 | | | | | |
| Comp. | — | Ru—30at.%Cr | 5.2 | 2.7 | 21.5 |
| Ex. 1-1 | | | | | |
| Comp. | Ni—6at.%W— | Ru | 5.1 | 2.7 | 21.6 |
| Ex. 1-2 | 3mol%WO₃ | | | | |
| Comp. | — | Ru | 5.0 | 2.8 | 21.4 |
| Ex. 1-3 | | | | | |

A comparison of the media corresponding to Illustrative Embodiment 1-1 and Comparative Examples 1-1 to 1-3 showed that the coercive force Hc and crystalline orientation were comparable in all the media, but the SNR was best in the medium of the Illustrative Embodiment I. In order to compare the microstructures of the media, the recording layers were observed under a transmission electron microscope (Hitachi, H-9000NAR).

A transmission electron microscope (Hitachi, H-9000NAR) was used to analyze the microstructures of the recording layers (i.e., 812 of FIG. 8) in the media. Table 3 shows the results of the magnetic recording layer grain size for the media corresponding to Illustrative Embodiment 1-1 and Comparative Examples 1-1 to 1-3.

TABLE 3

| | | 1st | Magnetic |
|---|---|---|---|
| | 2nd Seed | Intermediate | Recording Layer |
| | Layer | Layer | grain size (nm) |
| Ill. | Ni—6at.%W— | Ru—30at.%Cr | 9.3 |
| Emb. | 3mol%WO₃ | | |
| 1-1 | | | |
| Comp. | — | Ru—30at.%Cr | 9.4 |
| Ex. 1-1 | | | |
| Comp. | Ni—6at.%W— | Ru | 9.6 |
| Ex. 1-2 | 3mol%WO₃ | | |
| Com. | — | Ru | 9.5 |
| Ex. 1-3 | | | |

As indicated in Table 3, the average grain sizes in the magnetic recording layers of all the media were comparable.

The TEM images of the microstructure of the magnetic recording layer in each of the media were further analyzed in detail. It was found that for each of the media, all of the crystal grains in the magnetic recording layer had an hcp structure with the (0001) plane oriented parallel or substantially parallel to the substrate. For each media, the a-axis orientation of the hcp-structure crystal grain in the magnetic recording layer was first identified, and then the difference in the a-axis orientation of adjacent crystal grains in the magnetic recording layer was then determined. This procedure was implemented for all the crystal grains in the magnetic recording layer of the media. Groups of crystal grains in the magnetic recording layer for which the difference in the a-axis orientation of adjacent crystal grains was less than 1° were deemed to be crystalline clusters.

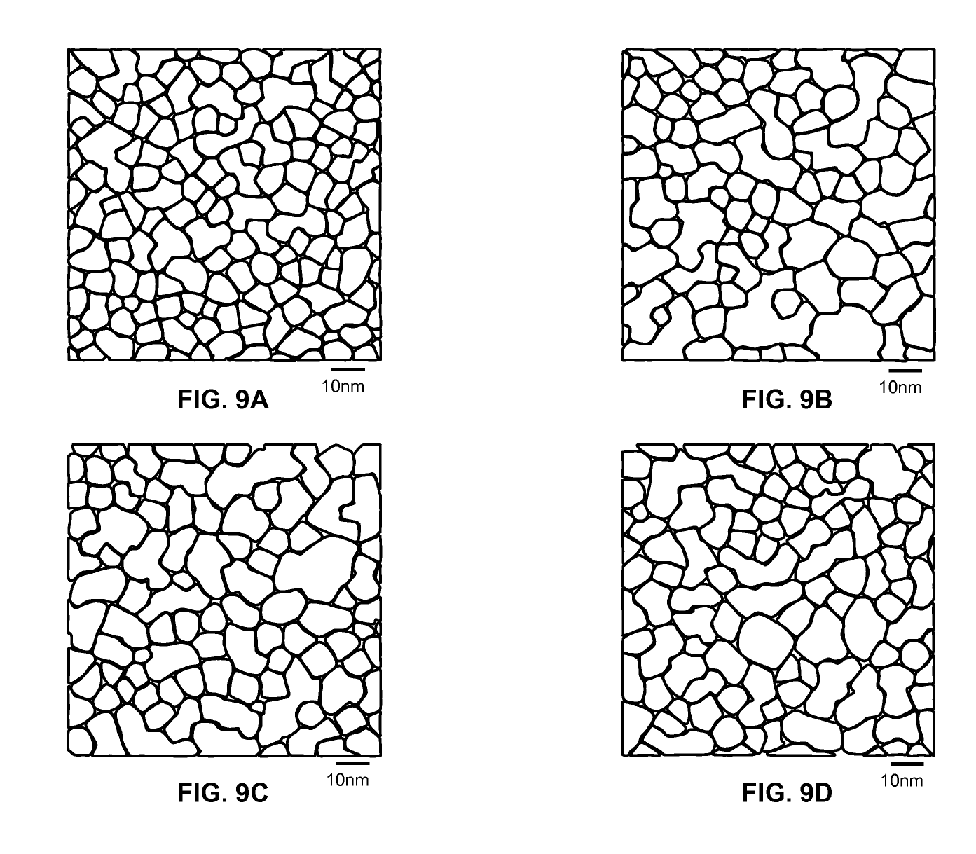

FIGS. 9A-9D shows schematic diagrams of the crystalline clusters in the magnetic recording layer of the media corresponding to Illustrative Embodiment 1-1 (FIG. 9A), Comparative Examples 1-1 (FIG. 9B), Comparative Example 1-2 (FIG. 9C), and Comparative Example 1-3 (FIG. 9D). Crystalline clusters formed of multiple crystal grains were apparent for all of the media. Large crystalline clusters were those that were 20 nm or greater in size.

Table 4 shows the average crystalline cluster size and the dispersion thereof in the magnetic recording layer of the media corresponding to Illustrative Embodiment 1-1 and Comparative Examples 1-1 to 1-3.

TABLE 4

| | | | Magnetic Recording Layer | |
|---|---|---|---|---|
| | | 1st | crystalline | |
| | 2nd Seed | Intermediate | cluster size | sigma |
| | Layer | Layer | (nm) | (nm) |
| Ill. | Ni—6at.%W— | Ru—30at.%Cr | 10.3 | 2.32 |
| Emb. | 3mol%WO₃ | | | |
| 1-1 | | | | |
| Comp. | — | Ru—30at.%Cr | 12.8 | 3.96 |
| Ex. 1-1 | | | | |
| Comp. | Ni—6at.%W— | Ru | 12.6 | 3.69 |
| Ex. 1-2 | 3mol%WO₃ | | | |
| Comp. | — | Ru | 12.4 | 3.40 |
| Ex. 1-3 | | | | |

As indicated in Table 4, the magnetic recording layer of the medium of Illustrative Embodiment I had a small average crystalline cluster size and dispersion. It is believed that the SNR of the medium of Illustrative Embodiment I was improved as a result.

### Illustrative Embodiment 1-2 vs. Comparative Examples 1-4 to 1-6

For the perpendicular magnetic recording media corresponding to Illustrative Embodiment 1-2, and Comparative Examples 1-4, 1-5, and 1-6, a target in which 4 mol % Sift and 4 mol % TiO₂ were added to a Co-10 at % Cr-20 at % Pt alloy was used to form the magnetic recording layer to a thickness of 10 nm under a gas pressure of 4 Pa, where the gas was a mixture of 0.5% oxygen with Ar. Aside from the magnetic recording layer, Illustrative Embodiment 1-2 was otherwise identical to Illustrative Embodiment 1-1. Likewise, aside from the magnetic recording layer, Comparative Examples 1-4, 1-5, and 1-6 were otherwise identical to Comparative Examples 1-1, 1-2, and 1-3, respectively.

A summary of the layers included in the magnetic media of Illustrative Embodiment 1-2, and Comparative Examples 1-1 is provided in Table 5, below.

TABLE 5

| Recording | (Co—10at%Cr—20at%Pt)—4mol%SiO₂—4mol%TiO₂ | | | |
|---|---|---|---|---|
| Layer | | | | |
| 3^{rd} Interlayer | (Ru—30at%Ti)— | (Ru—30at%Ti)— | (Ru—30at%Ti)— | (Ru—30at%Ti)— |
| | 10mol%TiO₂ | 10mol%TiO₂ | 10mol%TiO₂ | 10mol%TiO₂ |
| 2^{nd} Interlayer | Ru | Ru | Ru | Ru |
| 1^{st} Interlayer | Ru—30at%Cr | Ru—30at%Cr | Ru | Ru |
| 2^{nd} Seed Layer | (Ni—6at%W)— | — | (Ni—6at%W)— | — |
| | 3mol%WO₃ | | 3mol%WO₃ | |
| 1^{st} Seed Layer | Ni—10at%Cr— | Ni—10at%Cr— | Ni—10at%Cr— | Ni—10at%Cr— |
| | 6at%W | 6at%W | 6at%W | 6at%W |
| | Ill. Emb. 1-2 | Comp. Ex. 1-1 | Comp. Ex. 1-2 | Comp. Ex. 1-3 |

Table 6 shows the average grain size, crystalline cluster size, and magnetic cluster size in the magnetic recording layer of the media corresponding to Illustrative Embodiment 1-2 and Comparative Examples 1-4 to 1-6.

TABLE 6

| | | | Magnetic Recording Layer | | |
|---|---|---|---|---|---|
| | | | | crystalline | magnetic |
| | | 1st | grain | cluster | cluster |
| | 2nd Seed | Intermediate | size | size | size |
| | Layer | Layer | (nm) | (nm) | (nm) |
| Ill. | Ni—6at.%W— | Ru—30at.%Cr | 9.3 | 10.4 | 10.6 |
| Emb. | 3mol%WO₃ | | | | |
| 1-2 | | | | | |
| Comp. | — | Ru—30at.%Cr | 9.4 | 12.8 | 12.5 |
| Ex. 1-4 | | | | | |
| Comp. | Ni—6at.%W— | Ru | 9.5 | 12.5 | 12.3 |
| Ex. 1-5 | 3mol%WO₃ | | | | |
| Comp. | — | Ru | 9.5 | 12.4 | 12.4 |
| Ex. 1-6 | | | | | |

As indicated in Table 6, the magnetic recording layers of the media corresponding to Illustrative Embodiment 1-2 and Comparative Examples 1-4 to 1-6 all had comparable average grain sizes, and a magnetic cluster size that was a larger value than their respective average grain sizes. Ideally, the average grain size and magnetic cluster size should be the same if the crystal grains are completely isolated; however, this was not achieved in any of the media displayed in Table 6. Furthermore, the magnetic recording layers of the media corresponding to Illustrative Embodiment 1-2 and Comparative Examples 1-4 to 1-6 had a comparable magnetic cluster size and crystalline cluster size. Crystalline clusters were taken as the smallest units of magnetization reversal. However, it was still apparent that the crystalline cluster size and magnetic cluster size were smallest in the magnetic recording layer of the medium corresponding to Illustrative Embodiment 1-2.

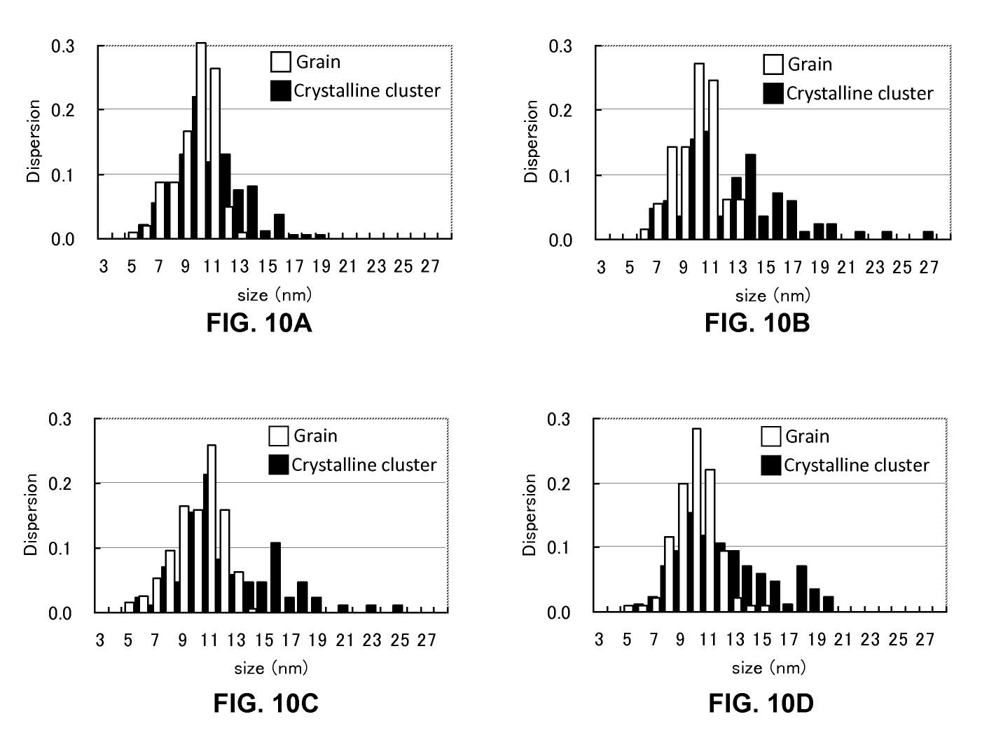

FIGS. 10A-10D show histograms of the grain size and crystalline clusters in the magnetic recording layers of the media corresponding to Illustrative Embodiment 1-2 (FIG. 10A), Comparative Example 1-4 (FIG. 10B), Comparative Example 1-5 (FIG. 10C), and Comparative Example 1-6 (FIG. 10C). As shown in FIG. 10A, the distributions of the grain size and crystalline cluster size were very similar in shape and there were few large crystalline clusters. In contrast, FIGS. 10B-10D illustrate grain size and crystalline cluster size distributions which have varying shapes, as well as the presence of many large crystalline clusters. Looking at Comparative Examples 1-4 and 1-6, it was clear that the crystalline cluster size could not be reduced simply by adding Cr to the first interlayer. Moreover, looking at Comparative Examples 1-5 and 1-6, it was clear that the crystalline cluster size could not be reduced even by combining a Ru interlayer with the second seed layer to which oxide had been added. However, it was clear that the formation of large crystalline clusters could be suppressed and the magnetic cluster size could be reduced in approaches when a RuCr first interlayer and a second oxide seed layer were combined, in accordance with medium corresponding to Illustrative Embodiment 1-2.

### Illustrative Embodiments 2-1 to 2-4 vs. Comparative Examples 2-1 to 2-3

Illustrative Embodiments 2-1 to 2-4 correspond to perpendicular magnetic recording media that include the same basic structure, materials, thicknesses, etc. as the medium of Illustrative Embodiment 1-1 (see e.g., medium 800 of FIG. 8), except for the particular composition of the first interlayer 810A. In particular, Illustrative Embodiment 2-1 corresponds to a perpendicular magnetic recording medium having a first interlayer 810A with Ru-10 at % Cr, but is otherwise identical to the perpendicular magnetic recording medium of Illustrative Embodiment 1-1. Illustrative Embodiment 2-2 corresponds to a perpendicular magnetic recording medium having a first interlayer 810A with Ru-20 at % Cr, but is otherwise identical to the perpendicular magnetic recording medium of Illustrative Embodiment 1-1. Illustrative Embodiment 2-3 corresponds to a perpendicular magnetic recording medium having a first interlayer 810A with Ru-30 at % Cr, and is thus identical to the perpendicular magnetic recording medium of Illustrative Embodiment 1-1. Illustrative Embodiment 2-4 corresponds to a perpendicular magnetic recording medium having a first interlayer 810A with Ru-40 at % Cr, but is otherwise identical to the perpendicular magnetic recording medium of Illustrative Embodiment 1-1.

Comparative Examples 2-1 to 2-3 also correspond to perpendicular magnetic recording media that include the same basic structure, materials, thicknesses, etc. as the medium of Illustrative Embodiment 1-1 (see e.g., medium 800 of FIG. 8), except for the particular composition of the first interlayer 810A. In particular, Comparative Example 2-1 corresponds to a perpendicular magnetic recording medium having a first interlayer 810A consisting only of Ru, but is otherwise identical to the perpendicular magnetic recording medium of Illustrative Embodiment 1-1. Comparative Example 2-2 corresponds to a perpendicular magnetic recording medium having a first interlayer 810A with Ru-5 at % Cr, but is otherwise identical to the perpendicular magnetic recording medium of Illustrative Embodiment 1-1. Finally, Comparative Example 2-3 corresponds to a perpendicular magnetic recording medium having a first interlayer 810A with Ru-50 at % Cr, but is otherwise identical to the perpendicular magnetic recording medium of Illustrative Embodiment 1-1.

Table 7 shows the magnetic characteristics (Hc), crystalline orientation (θ50), medium SNR, and average crystalline cluster size for the perpendicular magnetic recording media corresponding to Illustrative Embodiments 2-1 to 2-4 and Comparative Examples 2-1 to 2-3.

TABLE 7

| | | Magnetic Recording Layer | | | |
|---|---|---|---|---|---|
| | 1st | | | | crystalline |
| | Intermediate | Hc | Δθ50 | SNR | cluster size |
| | Layer | (kOe) | (degree) | (dB) | (nm) |
| Ill. Emb. 2-1 | Ru—10at.%Cr | 5.1 | 2.8 | 22.6 | 10.7 |
| Ill. Emb. 2-2 | Ru—20at.%Cr | 5.1 | 2.7 | 22.9 | 10.5 |
| Ill. Emb. 2-3 | Ru—30at.%Cr | 5.1 | 2.7 | 23.0 | 10.3 |
| Ill. Emb. 2-4 | Ru—40at.%Cr | 5.0 | 2.8 | 22.8 | 10.3 |
| Comp. Ex. 2-1 | Ru | 5.0 | 2.8 | 21.4 | 12.4 |
| Comp. Ex. 2-2 | Ru—5at.%Cr | 5.1 | 2.8 | 21.5 | 12.3 |
| Comp. Ex. 2-3 | Ru—50at.%Cr | 4.4 | 3.3 | 19.8 | — |

As indicated in Table 7, the perpendicular magnetic recording media corresponding to Illustrative Embodiments 2-1 to 2-4 all had a high SNR. With regard to the perpendicular magnetic recording medium of Comparative Example 2-2, it was clear that when the Cr concentration was low, good crystalline orientation was achieved, but high medium SNR was not achieved, and the average crystalline cluster size was large. For the perpendicular magnetic recording medium of Comparative Example 2-3, it was clear that when the Cr concentration was high, the crystalline orientation deteriorated and the medium SNR decreased. In view of the above, the concentration of Cr added to the first interlayer may preferably be in the range of 10 at % to 40 at %.

### Illustrative Embodiments 2-5 to 2-8 vs. Comparative Examples 2-4 and 2-5

Illustrative Embodiments 2-5 to 2-8 correspond to perpendicular magnetic recording media that include the same basic structure, materials, thicknesses, etc. as the medium of Illustrative Embodiment 1-1 (see e.g., medium 800 of FIG. 8), except for the thickness of the first interlayer 810A. In particular, Illustrative Embodiment 2-5 corresponds to a perpendicular magnetic recording medium having a first interlayer 810A with a thickness of 2 nm, but is otherwise identical to the perpendicular magnetic recording medium of Illustrative Embodiment 1-1. Illustrative Embodiment 2-6 corresponds to a perpendicular magnetic recording medium having a first interlayer 810A with a thickness of 4 nm, and is thus identical to the perpendicular magnetic recording medium of Illustrative Embodiment 1-1. Illustrative Embodiment 2-7 corresponds to a perpendicular magnetic recording medium having a first interlayer 810A with a thickness of 6 nm, but it otherwise identical to the perpendicular magnetic recording medium of Illustrative Embodiment 1-1. Illustrative Embodiment 2-8 corresponds to a perpendicular magnetic recording medium having a first interlayer 810A with a thickness of 8 nm, but is otherwise identical to the perpendicular magnetic recording medium of Illustrative Embodiment 1-1.

Comparative Examples 2-4 and 2-5 correspond to perpendicular magnetic recording media that include the same basic structure, materials, thicknesses, etc. as the medium of Illustrative Embodiment 1-1 (see e.g., medium 800 of FIG. 8), except for the thickness of the first interlayer 810A. In particular, Comparative Example 2-4 corresponds to a perpendicular magnetic recording medium having a first interlayer 810A with a thickness of 1 nm, but is otherwise identical to the perpendicular magnetic recording medium of Illustrative Embodiment 1-1. Finally, Comparative Example 2-5 corresponds to a perpendicular magnetic recording medium having a first interlayer 810A with a thickness of 10 nm, but is otherwise identical to the perpendicular magnetic recording medium of Illustrative Embodiment 1-1.

Table 8 shows the magnetic characteristics (Hc), crystalline orientation (ΔΘ50), medium SNR, and overwrite (OW) characteristics for the perpendicular magnetic recording media corresponding to Illustrative Embodiments 2-5 to 2-8 and Comparative Examples 2-4 and 2-5. To measure the OW characteristics, a signal of 4590 fr/mm was written over a signal of 27560 fr/mm, and the ratio of the residual component of the 27560 fr/mm signal to the intensity of the 4590 fr/mm signal was obtained.

TABLE 8

| | 1st Intermediate | Magnetic Recording Layer | | | |
|---|---|---|---|---|---|
| | Layer Thickness | Hc | Δθ50 | SNR | OW |
| | (nm) | (kOe) | (degree) | (dB) | (dB) |
| Ill. Emb. 2-5 | 2 | 5.1 | 2.9 | 23.0 | −34.3 |
| Ill. Emb. 2-6 | 4 | 5.1 | 2.7 | 23.0 | −32.1 |
| Ill. Emb. 2-7 | 6 | 5.2 | 2.5 | 22.9 | −31.6 |
| Ill. Emb. 2-8 | 8 | 5.3 | 2.4 | 22.8 | −29.0 |
| Comp. Ex. 2-4 | 1 | 4.6 | 3.5 | 19.9 | −36.0 |
| Comp. Ex. 2-5 | 10 | 5.4 | 2.3 | 21.0 | −26.0 |

As indicated in Table 8, in approaches where the thickness of the first interlayer was in a range between 2 nm to 8 nm, as in the media of Illustrative Embodiments 2-5 to 2-8, it was possible to achieve good crystalline orientation and medium SNR in the respective magnetic recording layers. However, in approaches where the thickness of the first interlayer was at 1 nm, as in Comparative Example 2-4, the crystalline orientation of the magnetic recording layer clearly deteriorated and the medium SNR decreased. Further, in approaches where the first interlayer was excessively thick, as in Comparative Example 2-5, good crystalline orientation in the magnetic recording layer was achieved, but the OW was inadequate and the medium SNR deteriorated. In view of the above, the thickness of the first interlayer may preferably be in the range of 2 nm to 8 nm.

### Illustrative Embodiments 3-1 to 3-4 vs. Comparative Examples 3-1 to 3-2

Illustrative Embodiments 3-1 to 3-4 correspond to perpendicular magnetic recording media that include the same basic structure, materials, thicknesses, etc. as the medium of Illustrative Embodiment 1-1 (see e.g., medium 800 of FIG. 8), except for the particular oxide content of the second seed layer 808B. In particular, Illustrative Embodiment 3-1 corresponds to a perpendicular magnetic recording medium having a second seed layer 808B with Ni-6 at % W-2 mol % WO₃, but is otherwise identical to the perpendicular magnetic recording medium of Illustrative Embodiment 1-1. Illustrative Embodiment 3-2 corresponds to a perpendicular magnetic recording medium having a second seed layer 808B with Ni-6 at % W-3 mol % WO₃, but is thus identical to the perpendicular magnetic recording medium of Illustrative Embodiment 1-1. Illustrative Embodiment 3-3 corresponds to a perpendicular magnetic recording medium having a with Ni-6 at % W-4 mol % WO₃, but is otherwise identical to the perpendicular magnetic recording medium of Illustrative Embodiment 1-1. Illustrative Embodiment 3-4 corresponds to a perpendicular magnetic recording medium having a second seed layer 808B with Ni-6 at % W-5 mol % WO₃, but is otherwise identical to the perpendicular magnetic recording medium of Illustrative Embodiment 1-1.

Comparative Examples 3-1 to 3-2 also correspond to perpendicular magnetic recording media that include the same basic structure, materials, thicknesses, etc. as the medium of Illustrative Embodiment 1-1 (see e.g., medium 800 of FIG. 8), except for the particular oxide content of the second seed layer 608B. In particular, Comparative Example 3-1 corresponds to a perpendicular magnetic recording medium having a second seed layer 808B with Ni-6 at % W-1 mol % WO₃, but is otherwise identical to the perpendicular magnetic recording medium of Illustrative Embodiment 1-1. Finally, Comparative Example 3-2 corresponds to a perpendicular magnetic recording medium having a second seed layer 808B with Ni-6 at % W-6 mol % WO₃, but is otherwise identical to the perpendicular magnetic recording medium of Illustrative Embodiment 1-1.

Table 9 shows the magnetic characteristics (Hc), crystalline orientation (050), medium SNR, and average crystalline cluster size for the perpendicular magnetic recording media corresponding to Illustrative Embodiments 3-1 to 3-4 and Comparative Examples 3-1 and 3-2.

TABLE 9

| | | Magnetic Recording Layer | | | |
|---|---|---|---|---|---|
| | | | | | crystalline |
| | 2nd Seed | Hc | Δθ50 | SNR | cluster size |
| | Layer | (kOe) | (degree) | (dB) | (nm) |
| Ill. Emb. 3-1 | Ni—6at.%W— | 5.1 | 2.7 | 23.0 | 10.5 |
| | 2mol%WO₃ | | | | |
| Ill. Emb. 3-2 | Ni—6at.%W— | 5.1 | 2.7 | 23.0 | 10.3 |
| | 3mol%WO₃ | | | | |
| Ill. Emb. 3-3 | Ni—6at.%W— | 5.1 | 2.8 | 23.0 | 10.3 |
| | 4mol%WO₃ | | | | |
| Ill. Emb. 3-4 | Ni—6at.%W— | 5.1 | 2.8 | 22.9 | 10.3 |
| | 5mol%WO₃ | | | | |
| Comp. Ex. 3-1 | Ni—6at.%W— | 5.0 | 2.8 | 21.2 | 12.3 |
| | 1mol%WO₃ | | | | |
| Comp. Ex. 3-2 | Ni—6at.%W— | 4.7 | 3.6 | 19.6 | — |
| | 6mol%WO₃ | | | | |

As indicated in Table 9, the magnetic recording layers of the media corresponding to Illustrative Embodiments 3-1 to 3-4 all showed good crystalline orientation, high medium SNR, and a small average crystalline cluster size. In approaches where the oxide content in the second seed layer was low, as in Comparative Example 3-1, good crystalline orientation was achieved, but high medium SNR was not achieved. Without wishing to be bound by any particular theory, it is nevertheless thought that the improved recording characteristics, as exhibited in the media corresponding to the Illustrative Embodiments and other inventive embodiments disclosed herein, cannot be achieved without reducing the crystalline cluster size. In approaches where the oxide content in the second seed layer was high, as in Comparative Example 3-2, the crystalline orientation deteriorated and high medium SNR was not achieved. It is therefore considered important to reduce the crystalline cluster size while maintaining the crystalline orientation.

### Illustrative Embodiments 3-5 to 3-8 vs. Comparative Examples 3-3 and 3-4

Illustrative Embodiments 3-5 to 3-8 correspond to perpendicular magnetic recording media that include the same basic structure, materials, thicknesses, etc. as the medium of Illustrative Embodiment 1-1 (see e.g., medium 800 of FIG. 8), except for the thickness of the second seed layer 808B. In particular, Illustrative Embodiment 3-5 corresponds to a perpendicular magnetic recording medium having a second seed layer 808B with a thickness of 1 nm, but is otherwise identical to the perpendicular magnetic recording medium of Illustrative Embodiment 1-1. Illustrative Embodiment 3-6 corresponds to a perpendicular magnetic recording medium having a second seed layer 808B with a thickness of 2 nm, and is thus identical to the perpendicular magnetic recording medium of Illustrative Embodiment 1-1. Illustrative Embodiment 3-7 corresponds to a perpendicular magnetic recording medium having a second seed layer 808B with a thickness of 3 nm, but it otherwise identical to the perpendicular magnetic recording medium of Illustrative Embodiment 1-1. Illustrative Embodiment 3-8 corresponds to a perpendicular magnetic recording medium having a second seed layer 808B with a thickness of 4 nm, but is otherwise identical to the perpendicular magnetic recording medium of Illustrative Embodiment 1-1.

Likewise, Comparative Examples 3-3 and 3-4 correspond to perpendicular magnetic recording media that include the same basic structure, materials, thicknesses, etc. as the medium of Illustrative Embodiment 1-1 (see e.g., medium 800 of FIG. 8), except for the thickness of the second seed layer 808B. In particular, Comparative Example 3-3 corresponds to a perpendicular magnetic recording medium having a second seed layer 808B with a thickness of 0.5 nm, but is otherwise identical to the perpendicular magnetic recording medium of Illustrative Embodiment 1-1. Finally, Comparative Example 3-4 corresponds to a perpendicular magnetic recording medium having a second seed layer 808B with a thickness of 5 nm, but is otherwise identical to the perpendicular magnetic recording medium of Illustrative Embodiment 1-1.

Table 10 shows the magnetic characteristics (Hc), crystalline orientation (ΔΘ50), medium SNR, and average crystalline cluster size for the perpendicular magnetic recording media corresponding to Illustrative Embodiments 3-5 to 3-8 and Comparative Examples 3-3 and 3-4.

TABLE 10

| | 2nd Seed | Magnetic Recording Layer | | | |
|---|---|---|---|---|---|
| | Layer | | | | Crystalline |
| | Thickness | Hc | Δθ50 | SNR | cluster size |
| | (nm) | (kOe) | (degree) | (dB) | (nm) |
| Ill. Emb. 3-5 | 1 | 5.1 | 2.7 | 22.9 | 10.6 |
| Ill. Emb. 3-6 | 2 | 5.1 | 2.7 | 23.0 | 10.3 |
| Ill. Emb. 3-7 | 3 | 5.1 | 2.7 | 23.0 | 10.3 |
| Ill. Emb. 3-8 | 4 | 5.0 | 2.8 | 22.8 | 10.4 |
| Comp. Ex. 3-3 | 0.5 | 5.0 | 2.8 | 21.2 | 12.3 |
| Comp. Ex. 3-4 | 5 | 4.3 | 3.7 | 19.7 | — |

As indicated in Table 10, the magnetic recording layers of the media corresponding to Illustrative Embodiments 3-5 to 3-8 all showed good crystalline orientation, high medium SNR, and a small average crystalline cluster size. In approaches where the thickness of the second seed layer was 0.5 nm, as in Comparative Example 3-3, good crystalline orientation was achieved, but there was no effect of reducing the crystalline cluster size and high medium SNR was not achieved. In approaches where the thickness of the second seed layer was increased, as in Comparative Example 3-4, the crystalline orientation deteriorated and high medium SNR was not achieved. The second seed layer may therefore preferably be in the range between 1 nm to 4 nm in order to maintain the crystalline orientation while reducing the crystalline cluster size.

### Illustrative Embodiments 4-1 to 4-16 vs. Comparative Examples 4-1 to 4-14

Illustrative Embodiments 4-1 to 4-16 and Comparative Examples 4-1 to 4-14 correspond to perpendicular magnetic recording media that include the same basic structure, materials, thicknesses, etc. as the medium of Illustrative Embodiment 1-1 (see e.g., medium 800 of FIG. 8), except for the particular Ru alloy and content of the alloying element (i.e. the element other than Ru) present in the first interlayer 810A. Table 11 shows the particular Ru alloy present in the first interlayer 810A of the media corresponding to Illustrative Embodiments 4-1 to 4-16 and Comparative Examples 4-1 to 4-14. Table 11 also shows the magnetic characteristics (Hc), crystalline orientation (Δθ50), medium SNR, and average crystalline cluster size of the magnetic recording layers of said media.

TABLE 11

| | | Magnetic Recording Layer | | | |
|---|---|---|---|---|---|
| | 1st | | | | crystalline |
| | Intermediate | Hc | Δθ50 | SNR | cluster size |
| | Layer | (kOe) | (degree) | (dB) | (nm) |
| Ill. Emb. 4-1 | Ru—10at.%Ta | 5.0 | 2.8 | 22.9 | 10.9 |
| Ill. Emb. 4-2 | Ru—20at.%Ta | 4.9 | 2.8 | 22.8 | 10.7 |
| Ill. Emb. 4-3 | Ru—10at.%W | 5.2 | 2.7 | 22.6 | 10.6 |
| Ill. Emb. 4-4 | Ru—20at.%W | 5.3 | 2.6 | 23.0 | 10.4 |
| Ill. Emb. 4-5 | Ru—40at.%W | 5.1 | 2.7 | 22.6 | 10.7 |
| Ill. Emb. 4-6 | Ru—10at.%Mo | 5.1 | 2.8 | 22.8 | 10.6 |
| Ill. Emb. 4-7 | Ru—30at.%Mo | 5.2 | 2.7 | 23.0 | 10.5 |
| Ill. Emb. 4-8 | Ru—50at.%Mo | 5.0 | 2.8 | 22.6 | 10.7 |
| Ill. Emb. 4-9 | Ru—10at.%Nb | 5.0 | 2.8 | 22.8 | 10.8 |
| Ill. Emb. 4-10 | Ru—20at.%Nb | 4.9 | 2.8 | 22.7 | 10.7 |
| Ill. Emb. 4-11 | Ru—10at.%V | 5.1 | 2.8 | 22.7 | 10.6 |
| Ill. Emb. 4-12 | Ru—20at.%V | 5.2 | 2.7 | 22.9 | 10.4 |
| Ill. Emb. 4-13 | Ru—30at.%V | 5.1 | 2.8 | 22.6 | 10.7 |
| Ill. Emb. 4-14 | Ru—10at.%Co | 5.2 | 2.7 | 22.8 | 10.9 |
| Ill. Emb. 4-15 | Ru—20at.%Co | 5.3 | 2.7 | 22.9 | 10.7 |
| Ill. Emb. 4-16 | Ru—40at.%Co | 5.1 | 2.8 | 22.6 | 10.8 |
| Comp. Ex. 4-1 | Ru—5at.%Ta | 5.0 | 2.8 | 21.3 | 12.2 |
| Comp. Ex. 4-2 | Ru—5at.%W | 5.0 | 2.7 | 21.1 | 12.5 |
| Comp. Ex. 4-3 | Ru—5at.%Mo | 4.9 | 2.7 | 21.0 | 12.7 |
| Comp. Ex. 4-4 | Ru—5at.%Nb | 4.9 | 2.8 | 21.2 | 12.3 |
| Comp. Ex. 4-5 | Ru—5at.%V | 5.0 | 2.8 | 21.3 | 12.5 |
| Comp. Ex. 4-6 | Ru—5at.%Co | 5.1 | 2.7 | 21.3 | 12.4 |
| Comp. Ex. 4-7 | Ru—25at.%Ta | 4.5 | 3.4 | 20.4 | — |
| Comp. Ex. 4-8 | Ru—50at.%W | 4.6 | 3.5 | 19.5 | — |
| Comp. Ex. 4-9 | Ru—60at.%Mo | 4.3 | 3.9 | 19.1 | — |
| Comp. Ex. 4-10 | Ru—25at.%Nb | 4.7 | 3.2 | 20.8 | — |
| Comp. Ex. 4-11 | Ru—35at.%V | 4.6 | 3.2 | 19.9 | — |
| Comp. Ex. 4-12 | Ru—50at.%Co | 4.2 | 3.4 | 20.1 | — |
| Comp. Ex. 4-13 | Ru—10at.%Ti | 4.3 | 3.7 | 19.4 | — |
| Comp. Ex. 4-14 | Ru—10at.%Si | 3.9 | 4.4 | 17.3 | — |

As indicated in Table 11, the media corresponding to Illustrative Embodiments 4-1 to 4-16 all showed good characteristics. In approaches where the content of the alloying element that is not Ru was low, as in Comparative Examples 4-1 to 4-6, the crystalline cluster size, and high medium SNR was not achieved. In approaches where Ru formed an hcp structure, as in Comparative Examples 4-7, 4-10 and 4-12, there was nevertheless a deterioration in the crystalline orientation and it was thus not possible to achieve high medium SNR. In approaches where the composition of the first interlayer was such that it had an hcp structure and another structure, as in Comparative Examples 4-8, 4-9 and 4-11, it was not possible to achieve high medium SNR because the crystalline orientation deteriorated. For Comparative Example 4-13, the Ru-10 at % Ti composition of the first interlayer formed an hcp structure, and although the content of Ti was relatively small, the crystalline orientation nonetheless deteriorated precluding the ability to obtain high medium SNR. In approaches where Si, which does not form a solid solution with Ru, was added to the first interlayer, as in Comparative Example 4-14, the crystalline orientation deteriorated and it was not possible to achieve high medium SNR. In view of the above, it is therefore preferable that the first interlayer must be a Ru alloy having an hcp structure, where additional alloying elements are selected which do not cause deterioration of the crystalline orientation.

### Illustrative Embodiments 5-1 to 5-8 vs. Comparative Examples 5-1 to 5-10

Illustrative Embodiments 5-1 to 4-8 and Comparative Examples 5-1 to 4-10 correspond to perpendicular magnetic recording media that include the same basic structure, materials, thicknesses, etc. as the medium of Illustrative Embodiment 1-1 (see e.g., medium 800 of FIG. 8), except for the particular oxide and/or oxide content present in the second seed layer 808B. Table 12 shows the particular oxide (and the amount thereof) that is present in the second seed layer 808B of the media corresponding to Illustrative Embodiments 5-1 to 5-8 and Comparative Examples 5-1 to 5-10. Table 12 also shows the magnetic characteristics (Hc), crystalline orientation (4050), medium SNR, and average crystalline cluster size of the magnetic recording layers of said media.

TABLE 12

| | 2nd Seed Layer | | Magnetic Recording Layer | | | |
|---|---|---|---|---|---|---|
| | | oxide | | | | crystalline |
| | | content | Hc | Δθ50 | SNR | cluster |
| | materials | (vol %) | (kOe) | (degree) | (dB) | size (nm) |
| Ill. Emb. | Ni-6 at. % W- | 7.4 | 5.2 | 2.7 | 22.8 | 10.8 |
| 5-1 | 2 mol % SiO₂ | | | | | |
| Ill. Emb. | Ni-6 at. % W- | 10.9 | 5.0 | 2.7 | 22.9 | 10.6 |
| 5-2 | 4 mol % SiO₂ | | | | | |
| Ill. Emb. | Ni-6 at. % W- | 20.0 | 4.9 | 2.8 | 22.8 | 10.6 |
| 5-3 | 6 mol % SiO₂ | | | | | |
| Ill. Emb. | Ni-6 at. % W- | 5.4 | 5.1 | 2.7 | 22.6 | 10.9 |
| 5-4 | 2 mol % TiO₂ | | | | | |
| Ill. Emb. | Ni-6 at. % W- | 12.8 | 5.0 | 2.8 | 22.9 | 10.6 |
| 5-5 | 5 mol % TiO₂ | | | | | |
| Ill. Emb. | Ni-6 at. % W- | 19.5 | 4.8 | 2.8 | 22.7 | 10.5 |
| 5-6 | 8 mol % TiO₂ | | | | | |
| Ill. Emb. | Ni-6 at. % W- | 7.0 | 5.1 | 2.7 | 23.0 | 10.4 |
| 5-7 | 1 mol % Ta₂O₅ | | | | | |
| Ill. Emb. | Ni-6 at. % W- | 18.7 | 5.0 | 2.8 | 22.9 | 10.4 |
| 5-8 | 3 mol % Ta₂O₅ | | | | | |
| Comp. Ex. | Ni-6 at. % W- | 3.8 | 5.2 | 2.7 | 20.8 | 12.3 |
| 5-1 | 1 mol % SiO₂ | | | | | |
| Comp. Ex. | Ni-6 at. % W- | 2.7 | 5.1 | 2.7 | 20.3 | 12.7 |
| 5-2 | 1 mol % TiO₂ | | | | | |
| Comp. Ex. | Ni-6 at. % W- | 3.6 | 5.1 | 2.8 | 20.0 | 12.5 |
| 5-3 | 0.5 mol % | | | | | |
| | Ta₂O₅ | | | | | |
| Comp. Ex. | Ni-6 at. % W- | 22.9 | 4.2 | 3.7 | 19.2 | — |
| 5-4 | 7 mol % SiO₂ | | | | | |
| Comp. Ex. | Ni-6 at. % W- | 21.6 | 4.5 | 3.5 | 19.4 | — |
| 5-5 | 9 mol % TiO₂ | | | | | |
| Comp. Ex. | Ni-6 at. % W- | 23.6 | 4.2 | 3.9 | 19.1 | — |
| 5-6 | 4 mol % Ta₂O₅ | | | | | |
| Comp. Ex. | Ni-6 at. % W- | 8.1 | 4.6 | 3.5 | 19.4 | — |
| 5-7 | 1 mol % Nb₂O₅ | | | | | |
| Comp. Ex. | Ni-6 at. % W- | 15.1 | 4.3 | 3.9 | 19.1 | — |
| 5-8 | 2 mol % Nb₂O₅ | | | | | |
| Comp. Ex. | Ni-6 at. % W- | 3.7 | 4.4 | 3.5 | 19.3 | — |
| 5-9 | 1 mol % Al₂O₃ | | | | | |
| Comp. Ex. | Ni-6 at. % W- | 10.5 | 4.1 | 4.0 | 18.6 | — |
| 5-10 | 3 mol % Al₂O₃ | | | | | |

As indicated in Table 12, the perpendicular magnetic recording media corresponding to Illustrative Embodiments 5-1 to 5-8 all exhibited good characteristics. In approaches where the oxide content was lower than 5 vol %, whatever the oxide, as in Comparative Examples 5-1 to 5-3, it was clear that the crystalline cluster size was not reduced, and it was not possible to achieve high medium SNR. In approaches where the oxide content was greater than 20 vol %, whatever the oxide, as in Comparative Examples 5-4 to 5-6, it was also clear that the crystalline orientation deteriorated and it was not possible to achieve high medium SNR. In approaches where the oxide was Nb₂O₅ or Al₂O₃, as in Comparative Examples 5-7 to 5-10, it was clear that the crystalline orientation deteriorated regardless of the oxide amount, and it was not possible to achieve high medium SNR. In view of the above, it is preferable that the second seed layer includes at least one of WO₃, SiO₂, TiO₂ or Ta₂O₅ in an amount between 5 vol % to 20 vol %, in order to achieve the desired characteristics.

It should also be noted that methodology presented herein for at least some of the various embodiments may be implemented, in whole or in part, in computer hardware, software, by hand, using specialty equipment, etc. and combinations thereof.

Moreover, any of the structures and/or steps may be implemented using known materials and/or techniques, as would become apparent to one skilled in the art upon reading the present specification.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A perpendicular magnetic recording medium, comprising:
a substrate;
a soft magnetic underlayer positioned above the substrate;
a seed layer structure positioned above the soft magnetic underlayer, the seed layer structure including a first seed layer and a second seed layer positioned above the first seed layer;
an interlayer structure positioned above the seed layer structure, the interlayer structure including a first interlayer, a second interlayer positioned above the first interlayer, and a third interlayer positioned above the second interlayer; and
a magnetic recording layer positioned above the interlayer structure;
wherein the second seed layer comprises a Ni alloy including at least one oxide,
wherein the first interlayer comprises a Ru alloy.

2. The perpendicular magnetic recording medium as recited in claim 1, wherein an amount of the oxide in the second seed layer is in a range between about 5 vol % to about 20 vol % based on a total volume of the second seed layer, and wherein the oxide is selected from a group consisting of: WO₃, SiO₂, TiO₂, and Ta₂O₅.

3. The perpendicular magnetic recording medium as recited in claim 1, wherein the Ni alloy of the second seed layer further includes, in addition to the oxide, at least one element selected from a group consisting of: Cr, W, V, Mo, Ta, and Nb.

4. The perpendicular magnetic recording medium as recited in claim 1, where a thickness of second seed layer is in a range between about 1 nm to about 4 nm.

5. The perpendicular magnetic recording medium as recited in claim 1, wherein the first seed layer has a face centered cubic (fcc) structure, and comprises a Ni alloy including at least one element selected from a group consisting of: Cr, W, V, Mo, Ta and Nb.

6. The perpendicular magnetic recording medium as recited in claim 5, wherein the first seed layer does not include an oxide.

7. The perpendicular magnetic recording medium as recited in claim 5, wherein a thickness of the first seed layer is in a range between about 2 nm to about 7 nm.

8. The perpendicular magnetic recording medium as recited in claim 1, wherein the first interlayer has a hexagonal close packed (hcp) structure.

9. The perpendicular magnetic recording medium as recited in claim 8, wherein the Ru alloy of the first interlayer includes an element selected from a group consisting of: Cr in a range from about 10 at % to about 40 at %, Ta in a range from about 10 at % to about 20 at %, W in a range from about 10 at % to about 40 at %, Mo in a range from about 10 at % to about 50 at %, Nb in a range from about 10 at % to about 20 at %, V in a range between about 10 at % to about 30 at %, and Co in a range between 10 at % to about 40 at %.

10. The perpendicular magnetic recording medium as recited in claim 1, wherein a thickness of the first interlayer is in a range between about 2 nm to about 8 nm.

11. The perpendicular magnetic recording medium as recited in claim 1, wherein the second interlayer comprises Ru and/or a Ru alloy.

12. The perpendicular magnetic recording medium as recited in claim 11, wherein an amount of Ru in the second interlayer is greater than the amount of Ru in the first interlayer.

13. The perpendicular magnetic recording medium as recited in claim 11, wherein the second interlayer comprises a Ru alloy including at least one element selected from a group consisting of: Cr, Ta, W, Mo, Nb, V and Co.

14. The perpendicular magnetic recording medium as recited in claim 1, wherein a thickness of the second interlayer is in a range between about 4 nm to about 14 nm.

15. The perpendicular magnetic recording medium as recited in claim 1, wherein the third interlayer comprises a Ru alloy including an element selected from a group consisting of: Ti in a range between about 20 at % to about 50 at %, Nb in a range between about 20 at % to about 50 at %, Al in a range between about 20 at % to about 40 at %, Ta in a range between about 30 at % to about 50 at %, and Si in a range between about 20 at % to about 40 at %.

16. The perpendicular magnetic recording medium as recited in claim 15, wherein the Ru alloy of the third interlayer further comprises an oxide of Ti, Nb, Al and/or Ni, wherein an amount of the oxide in the third interlayer is in a range from greater than 0 vol % to about 40 vol % based on a total volume of the third interlayer.

17. The perpendicular magnetic recording medium as recited in claim 1, wherein a thickness of the third interlayer is in a range between about 0.5 nm to about 2 nm.

18. The perpendicular magnetic recording medium as recited in claim 1, wherein the magnetic recording layer comprises a plurality of ferromagnetic crystal grains wherein the ferromagnetic crystal grains comprise a CoPt alloy including at least of: Cr, Ti, Ta, Ru, W, Mo, Cu, and B, wherein the ferromagnetic crystal grains are surrounded by at least one oxide of Si, Ti, Ta, B, Cr, W and Nb.

19. The perpendicular magnetic recording medium as recited in claim 18, wherein the magnetic recording layer comprises a plurality of layers, wherein a concentration of at least one of Co and Pt in the crystal grains is varied across the plurality of layers.

20. The perpendicular magnetic recording medium as recited in claim 18, wherein a non-granular magnetic recording layer is positioned above the magnetic recording layer, the non-granular magnetic recording layer comprising a CoCrPt alloy including at least one element selected from a group consisting of: B, Ta, Ru, Ti, W, Mo and Nb.

21. The perpendicular magnetic recording medium as recited in claim 1, wherein the soft magnetic underlayer comprises an amorphous alloy of Co and/or Fe, wherein the amorphous alloy further includes at least one element selected from a group consisting of: Ta, Nb, Zr, B, and Cr, wherein a thickness of the soft magnetic underlayer is in a range between about 10 nm to about 50 nm.

22. A magnetic data storage system, comprising:
at least one magnetic head;
a perpendicular magnetic recording medium as recited in claim 1;
a drive mechanism for passing the magnetic medium over the at least one magnetic head; and
a controller electrically coupled to the at least one magnetic head for controlling operation of the at least one magnetic head.

23. A method for forming a perpendicular magnetic recording medium, comprising:
providing a substrate;
forming a soft magnetic underlayer above the substrate;
forming a seed layer structure above the soft magnetic underlayer, the seed layer structure comprising a first seed layer and a second seed layer positioned above the first seed layer;
forming an interlayer structure above the seed layer structure, the interlayer structure comprising a first interlayer, a second interlayer positioned above the first interlayer, and a third interlayer positioned above the second interlayer; and
forming a magnetic recording layer above the interlayer structure,
wherein the second seed layer comprises a Ni alloy including at least one oxide,
wherein the first interlayer comprises a Ru alloy,
wherein the second interlayer is formed under a gas pressure that is higher than a gas pressure used to form the first interlayer.

24. The method as recited in claim 23, wherein the second interlayer is formed under a gas pressure that is greater than or equal to about 2 Pa, wherein the first interlayer is formed under a gas pressure in a range between about 0.5 Pa to about 1 Pa.

25. The method as recited in claim 23, wherein an amount of the oxide in the second seed layer is in a range between about 5 vol % to about 20 vol % based on a total volume of the second seed layer, wherein the first seed layer comprises a Ni alloy that does not include an oxide.
